(19) United States
(12) Patent Application Publication
(10) Pub. No.: US 2003/0158789 A1
(43) Pub. Date: Aug. 21, 2003

(54) Electronic merchandise distribution system, electronic merchandise distribution method, and program

(75) Inventors: Seiji Miura, Nishitama-gun (JP); Arata Ando, Fuchu-shi (JP); Akihiro Nonoyama, Komae-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/366,669

(22) Filed: Feb. 14, 2003

(30) Foreign Application Priority Data
Feb. 21, 2002 (JP) 2002-045157

(51) Int. Cl. G06F 17/60

(52) U.S. Cl. 705/26

(57) ABSTRACT

A viewer apparatus, content providing apparatus, advertisement providing apparatus, and electronic merchandise distribution system are connected to a network apparatus. Upon receiving excellent content information evaluated/analyzed by a content evaluation apparatus in accordance with a content buying request, a content buying apparatus in the distribution system transmits order data to the content providing apparatus, makes a content buying contract from replay data, and transmits a content and content information to a distribution apparatus. The distribution apparatus generates advertising space information from the content information, presents the advertising space information to the advertisement providing apparatus through an advertisement acquisition processing apparatus, and acquires advertising space sales, an advertising content, and advertising content information. The distribution apparatus distributes a program having advertising spaces with advertisements and contents inserted to the viewer apparatus, collects the advertising fee from the advertisement provider, and returns part of the advertising revenue to the content provider and viewer.

### BACKGROUND OF THE INVENTION

This application is based upon and claims the benefit of priority from the prior Japanese Patent Application No. 2002-045157 filed Feb. 21, 2002, the entire contents of which are incorporated herein by reference.

1. Field of the Invention

The present invention relates to an electronic merchandise distribution system, electronic merchandise distribution method, and program, in which a TV apparatus or the like which is installed at each home buys an excellent content from the viewer information of contents watched by a viewer apparatus and distributes the bought content combined with an advertisement to the consumer at a low cost.

2. Description of the Related Art

Generally, electronic merchandise includes contents provided by content providing companies such as providers on the Internet and advertising contents (to be referred to as advertisements hereinafter) provided by advertisement providing companies.

Conventionally, general consumers watch video and audio contents using viewer apparatuses. To determine an excellent content from many contents, a navigation system or the like is installed in the viewer apparatus, and an excellent content is determined on the basis of program selection information.

On the other hand, an advertisement provided by an advertisement provider uses an advertising space of a program. A desired advertisement is set in an advertising space of a program and provided to the consumer.

Hence, conventional electronic merchandise distribution and sales have exclusively been handled by content providers, program producers, and advertisement providers. This mechanism cannot positively promote excellent contents or advertisements and return the profit in accordance with the degree of contribution to the contents or advertisements watched.

More specifically, a technique for automatically selecting excellent contents on the basis of viewer information of viewer apparatuses is surely available. However, it is difficult to combine excellent contents with advertisements and distributes them in order to promote supply of advertisements using advertising spaces of programs. It is also difficult to distribute contents and advertisements while ensuring a degree of freedom for their combinations.

To place contents in the advertising spaces of programs, advertising space purchase fees (advertising fees) are necessary. However, there is no method of returning a profit from the advertising space purchase fee to the viewer, content provider, and system operator in accordance with their degrees of contribution to advertisement watching. Especially, profit return to the content creator or producer side of the content provider is important from the viewpoint of promoting production of excellent contents. However, there is no mechanism for returning the advertising revenue to the content provider yet.

### BRIEF SUMMARY OF THE INVENTION

It is an object of the present invention to provide an electronic merchandise distribution system, electronic merchandise distribution method, and program, which promote supply of excellent contents and advertisements.

It is another object of the present invention to provide an electronic merchandise distribution system, electronic merchandise distribution method, and program, in which each of a viewer, content provider, and system operator can appropriately receives a value according to the degree of contribution to advertisement watching.

In order to achieve the above objects, according to the present invention, there is provided an electronic merchandise distribution system which is connected to a network apparatus to which a viewer apparatus, content providing apparatus, and advertisement providing apparatus are connected, comprising: a content evaluation apparatus which, upon receiving a content buying request or the like, executes evaluation/analysis in accordance with a necessary evaluation method and evaluation items and outputs an evaluation/analysis result; and a content buying apparatus which, upon receiving excellent content information evaluated/analyzed by the content evaluation apparatus in accordance with the content buying request, transmits order data to the content providing apparatus and makes a content buying contract from reply data. With this arrangement, supply of excellent contents can be promoted.

A content distribution apparatus which receives a content and content information from the content buying apparatus, generates advertising space information from the content and content information, and provides the advertising space information to the advertisement providing apparatus may be added to the above constituent elements. In addition, an advertisement acquisition processing apparatus which causes the advertisement providing apparatus to display the advertising space information transmitted from the content distribution apparatus, and upon confirming the advertisement information and receiving an advertising space sales contract to insert an advertisement from the advertisement providing apparatus, acquires advertising content information and advertising content from the advertisement providing apparatus may be added.

With this arrangement, supply of excellent contents and advertisement can be promoted. In addition, a value corresponding to the degree of contribution to advertisement watching can be appropriately returned to each of the viewer, content provider, and system operator.

The above series of processing operations can also be realized by a method or processing by a program.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention and, together with the general description given above and the detailed description of the preferred embodiments given below, serve to explain the principles of the invention.

FIG. 1 is a block diagram showing the system configuration of a network system having an electronic merchandise distribution system according to an embodiment of the present invention;

FIGS. 2A and 2B are a flow chart for explaining the operation of the electronic merchandise distribution system shown in FIG. 1 and an electronic merchandise distribution method according to the embodiment of the present invention;

FIG. 3 is a flow chart for explaining, next to FIGS. 2A and 2B, the operation of the electronic merchandise distribution system shown in FIG. 1 and the electronic merchandise distribution method according to the embodiment of the present invention;

FIG. 4 is a view for explaining a sales model of a content with an advertisement when the electronic merchandise distribution system shown in FIG. 1 is used;

FIGS. 5A and 5B are block diagrams of a content buying apparatus according to the embodiment, which is a constituent element of the electronic merchandise distribution system shown in FIG. 1;

FIG. 6 is a flow chart for explaining processing of the content buying apparatus;

FIGS. 7A and 7B are block diagrams of a content evaluation apparatus according to the embodiment, which is a constituent element of the electronic merchandise distribution system shown in FIG. 1;

FIG. 8 is a flow chart for explaining processing of the content evaluation apparatus;

FIGS. 9A and 9B are block diagrams of a content distribution apparatus according to the embodiment, which is a constituent element of the electronic merchandise distribution system shown in FIG. 1;

FIGS. 10A and 10B are flow charts for explaining content information and content acquisition processing by the content processing section of the content distribution apparatus and processing of acquiring watching statistical information from the content evaluation apparatus;

FIG. 11 is a flow chart for explaining billing information acquisition by the content processing section of the content distribution apparatus;

FIG. 12 is a flow chart for explaining processing by the advertisement processing section of the content distribution apparatus;

FIG. 13 is a flow chart for explaining processing by the content-advertisement processing section of the content distribution apparatus;

FIG. 14 is a flow chart for explaining processing by the content selection promoting section of the content distribution apparatus;

FIG. 15 is a flow chart for explaining processing by the content-advertisement distribution section of the content distribution apparatus;

FIG. 16 is a block diagram of an advertisement acquisition processing apparatus according to the embodiment, which is a constituent element of the electronic merchandise distribution system shown in FIG. 1;

FIG. 17 is a block diagram of an advertisement providing apparatus according to the embodiment, which is connected to the network apparatus;

FIG. 18 is a flow chart for explaining processing by the advertisement acquisition processing apparatus;

FIG. 19 is a flow chart for explaining, next to FIG. 18, processing by the advertisement acquisition processing apparatus;

FIG. 20 is a sequence chart showing a protocol with which the advertisement acquisition processing apparatus receives advertising space information from the content distribution apparatus;

FIG. 21 is a view showing an advertisement insertion point model;

FIG. 22 is a sequence chart showing the credit information acquisition protocol of the advertisement acquisition processing apparatus;

FIG. 23 is a sequence chart showing the advertising space information display protocol of the advertisement acquisition processing apparatus;

FIG. 24 is a view showing an advertising space purchase window displayed on the display section of the advertisement providing apparatus;

FIG. 25 is a view showing contents and advertisement display window displayed on the monitor of the viewer apparatus;

FIG. 26 is a sequence chart showing a protocol with which the advertisement acquisition processing apparatus discloses watching information to the advertisement providing apparatus;

FIG. 27 is a sequence chart showing a protocol with which the advertisement providing apparatus receives bidding information from the advertisement acquisition processing apparatus; and

FIG. 28 is a sequence chart showing processing for causing the content distribution apparatus to receive distribution information from the advertisement acquisition processing apparatus.

### DETAILED DESCRIPTION OF THE INVENTION

An embodiment of the present invention will be described below with reference to the accompanying drawing.

### I. Overall Configuration of Network System Including Electronic Merchandise Distribution System

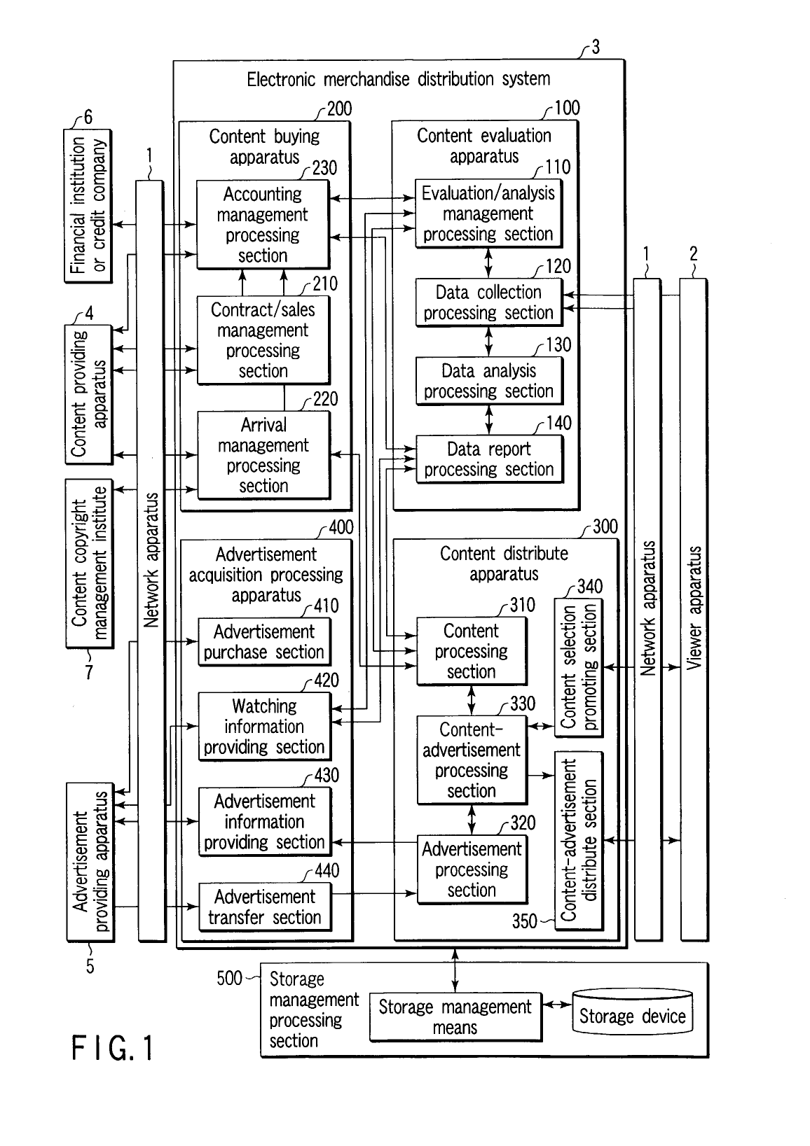

FIG. 1 is a block diagram showing the system configuration of a network system having an electronic merchandise distribution system according to the embodiment of the present invention.

The electronic merchandise distribution system has a network apparatus 1 such as the Internet which transmits global contents. A viewer apparatus 2, electronic merchandise distribution system 3, content providing apparatus 4, and advertisement providing apparatus 5 are connected to the network 1. The viewer apparatus 2 is held by a consumer including homes and companies. The viewer apparatus 2 is constituted by a TV apparatus that watches global contents including advertisements. The electronic merchandise distribution system 3 analyzes/evaluates excellent contents on the basis of viewer information output from the viewer apparatus 2 and required information acquired from the network apparatus 1, promotes supply of the excellent contents and advertisements, and returns appropriate values to the viewer, content provider, and system operator in accordance with their degrees of contribution to advertisement watching. The content providing apparatus 4 is held by a content provider or the like. The content providing apparatus 4 provides global contents to a number of viewer apparatuses 2 and also makes purchase contracts for excellent contents provided by the electronic merchandise distribution system 3. The advertisement providing apparatus 5 is held by an advertisement provider such as a sponsor company or an advertising agency, which makes a contract to insert an advertisement to an advertising space on the basis of advertising space information provided by the electronic merchandise distribution system 3.

In addition, a terminal 6 held by a financial institution or credit company serving as an external accounting settlement facility and a terminal 7 held by a content copyright information management institute for unitarily managing contents are connected to the network apparatus 1.

The viewer apparatus has at least the following functions.

The viewer apparatus 2 has at least a navigation system which holds personal information input by the consumer, executes program selection including timer programming, and acquires any other required information, a playback unit which acquires the start/end time of program playback, an SNMP (Simple Network Management) agent formed from software which defines information and how to output it, and an MIB (Management Information Base) database which stores information output by the SNMP agent.

The viewer apparatus 2 accesses the content providing apparatus 4 through the network apparatus 1 and watches a global content held by the content providing apparatus 4. In the viewer apparatus 2, the navigation system holds personal information that is input in advance and represents the attribute of each viewer to be identified as well as content information representing the attribute of a content under watching, the content watching time (zone), and any other required information. Hence, the viewer apparatus 2 has a function of, using the SNMP agent, generating and outputting content watching information containing the personal information representing the attribute of the viewer, the content information representing the attribute of the watched content, and the content watching time.

When the viewer has accessed and watched a content with an advertisement inserted, in which a content and an advertisement are combined, the viewer apparatus 2 holds advertisement information representing the attribute of the advertisement under watching and the advertisement watching time (zone) in addition to the personal information representing the attribute of the viewer who is watching the advertisement, as described above. Hence, the viewer apparatus 2 has a function of, using the SNMP agent, generating and outputting advertisement watching information containing the personal information representing the attribute of the viewer, the advertisement information representing the attribute of the watched advertisement, and the content watching time.

The electronic merchandise distribution system 3 has a content evaluation apparatus 100, content buying apparatus 200, content distribution apparatus 300, advertisement acquisition processing apparatus 400, and storage management processing section 500.

The content evaluation apparatus 100 receives content watching information collected from the viewer apparatus 2 or required information output by the SNMP agent of each terminal (not shown) installed in the network apparatus 1, executes predetermined evaluation and analysis for contents, selects excellent contents from global contents, and outputs content information containing content titles and access destinations.

The content buying apparatus 200 executes buying processing between itself and the content providing apparatus 4 on the basis of the content information of an excellent content, which is sent from the content evaluation apparatus 100, or an analysis/evaluation result obtained by selecting a content by itself and requesting the content evaluation apparatus 100 to evaluate/analyze that content. After buying is realized, the content buying apparatus 200 acquires the content and content information.

The content distribution apparatus 300 receives contents and content information sent from the content buying apparatus 200, generates and transmits a temporary program schedule and advertising space information on the basis of the contents and content information, and distributes the bought contents and advertisements.

The advertisement acquisition processing apparatus 400 provides advertisement information from the content distribution apparatus 300, sells advertising spaces, and acquires advertising contents.

The functions of the apparatuses 100 through 400 will be schematically described.

The content evaluation apparatus 100 is connected to a number of viewer apparatuses 2 through the network apparatus 1. The content evaluation apparatus 100 receives content watching information output from each viewer apparatus 2. The content evaluation apparatus 100 also receives required information collected from the network apparatus 1 and stores and manages the information in the storage management processing section 500. The content evaluation apparatus 100 evaluates contents using all pieces of collected content watching information and required information collected from the network apparatus 1, transmits content information containing excellent contents as well as content titles and access destinations to at least the content buying apparatus 200, and makes it buy the contents. The content evaluation apparatus 100 also receives pieces of content watching information of excellent contents from each viewer apparatus 2, stores and manages them in the storage management processing section 500, and provides an evaluation/analysis result later to the content providing apparatus 4 and the like.

The content evaluation apparatus 100 also receives pieces of advertisement watching information output from each viewer apparatus 2, stores and manages them in the storage management processing section 500, and provides an evaluation/analysis result later to the advertisement providing apparatus 5 and the like.

The content evaluation apparatus 100 has not only the function of transmitting excellent content information to the content buying apparatus 200 and making it to buy the contents but also a function of receiving a buying request for a selected content from the content buying apparatus 200, evaluating/analyzing the content information, and transmitting the evaluation/analysis result to the content buying apparatus 200.

The content evaluation apparatus 100 also has a function of calculating the advertising revenue, the advertisement consumption amount, and the degree of contribution of an advertisement-related content to advertisement watching, calculating the share for each of the consumer, content provider, and processing system operator in accordance with their degrees of contribution, and outputting the share result.

The content buying apparatus 200 is connected to the content evaluation apparatus 100 through communication lines (network) including dedicated lines. The content buying apparatus 200 receives the content information of excellent contents output from the content evaluation apparatus 100. On the basis of the content information of excellent contents sent from the content evaluation apparatus 100 in response to an evaluation/analysis request for content buying processing, the content buying apparatus 200 calculates the “original purchase prices” of the excellent contents and also calculates, on the basis of the “original purchase price”, the market “purchase price” and “sales price” of each of the contents that should be distributed with or without advertisements. In addition, on the basis of the calculated “purchase price” and “basic consumption price”, the content buying apparatus 200 automatically decides to make or not to make a purchase contract with the content providing apparatus 4 using an electronic means. The content providing apparatus 4 has a function of, after a purchase contract is made, sending a content and content information to a designated position of the content buying apparatus 200, storing and managing the content, content information, “original purchase price”, “purchase price”, and “sales price” in the storage management processing section 500, providing them to a requester as needed, and returning part of the advertising revenue to the content provider in accordance with its degree of contribution to advertisement watching.

The content distribution apparatus 300 is connected to the viewer apparatus 2 through the network apparatus 1. The content distribution apparatus 300 is also connected to the content evaluation apparatus 100, content buying apparatus 200, and advertisement acquisition processing apparatus 400 through communication lines (network) including dedicated lines.

The content distribution apparatus 300 receives program or content watching information from the viewer apparatus 2. In addition, the content distribution apparatus 300 acquires contents and content information bought by the content buying apparatus 200, receives watching statistical information from the content evaluation apparatus 100, and generates a program schedule, program guide information, advertising space information, and distribution control information. The content distribution apparatus 300 transmits the generated advertising space information to the advertisement acquisition processing apparatus 400 and the program guide information to the viewer apparatus 2. A program schedule arranges contents to be provided to the viewer apparatus 2 into the form of programs and creates corresponding program distribution control information and contents to be inserted into advertisements. The content distribution apparatus 300 also has a function of receiving program selection information from the viewer apparatus 2, searching for distribution control information corresponding to the program selection information, combining contents and advertisements in accordance with the distribution control information, executes conversion/compression processing, encryption processing, and distribution processing, and transmitting the contents to the viewer apparatus 2.

The advertisement acquisition processing apparatus 400 is connected to the content evaluation apparatus 100, content buying apparatus 200, and content distribution apparatus 300 through communication lines (network) including dedicated lines. The advertisement acquisition processing apparatus 400 is connected to the advertisement providing apparatus 5 through the network apparatus 1. The advertisement acquisition processing apparatus 400 receives “advertising space information” related to a distribution advertisement accompanying a content output from the content distribution apparatus 300, sends advertising space purchase information containing the content title and advertising space information to the advertisement providing apparatus 5, and executes advertising space purchase contract processing. After the advertising space purchase contract, the advertisement acquisition processing apparatus 400 receives an advertising content and advertising content information from the content providing apparatus 4, stores and manages them in the storage management processing section 500, and outputs the advertising content information as needed.

The content providing apparatus 4 is connected to the content buying apparatus 200 through the network apparatus 1. The content providing apparatus 4 has a function of executing contract processing by negotiating on the basis of content purchase contract conditions presented by the content buying apparatus 200 for content buying, and after a contract is made, sending the content and content information representing the attribute of the content to the content buying apparatus 200. The content providing apparatus 4 also has a function of receiving part of the advertising revenue from the content buying apparatus 200 in accordance with the degree of contribution to advertisement watching.

The advertisement providing apparatus 5 is connected to the content buying apparatus 200 through the network apparatus 1. The advertisement providing apparatus 5 has a function of executing advertising space purchase processing to make a purchase contract on the basis of advertising space purchase information such as a content title and advertising space information output from the advertisement acquisition processing apparatus 400, and sending the advertising content and advertising content information to the advertisement acquisition processing apparatus 400.

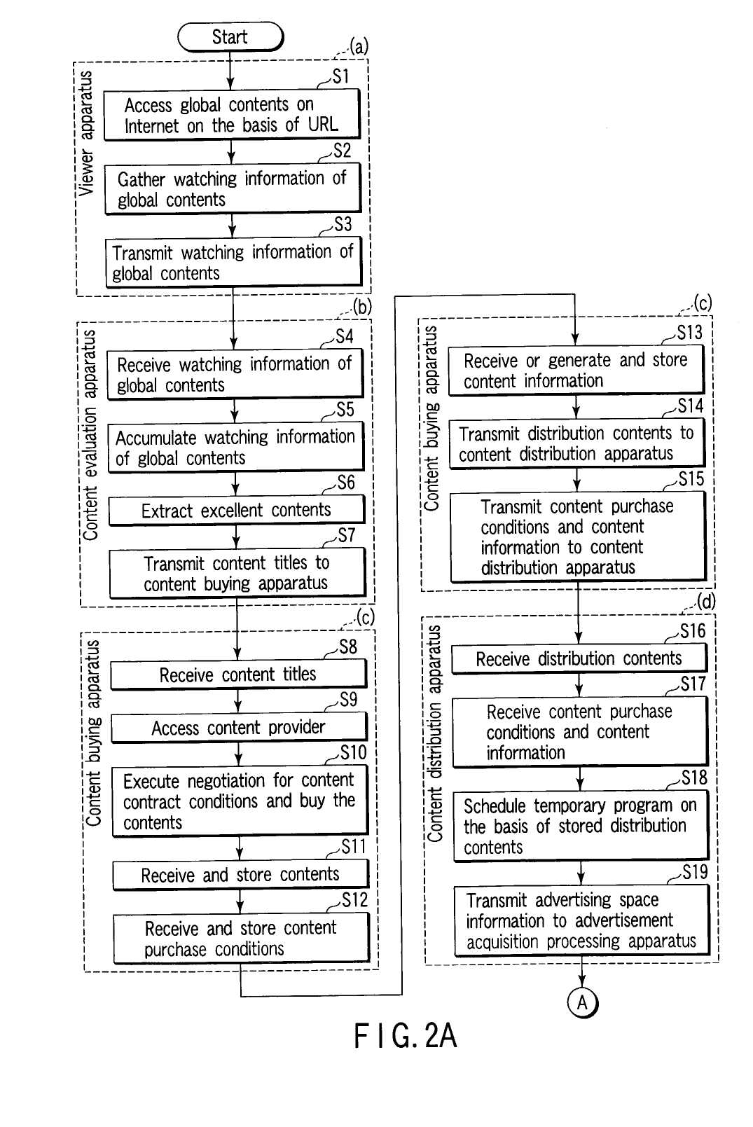

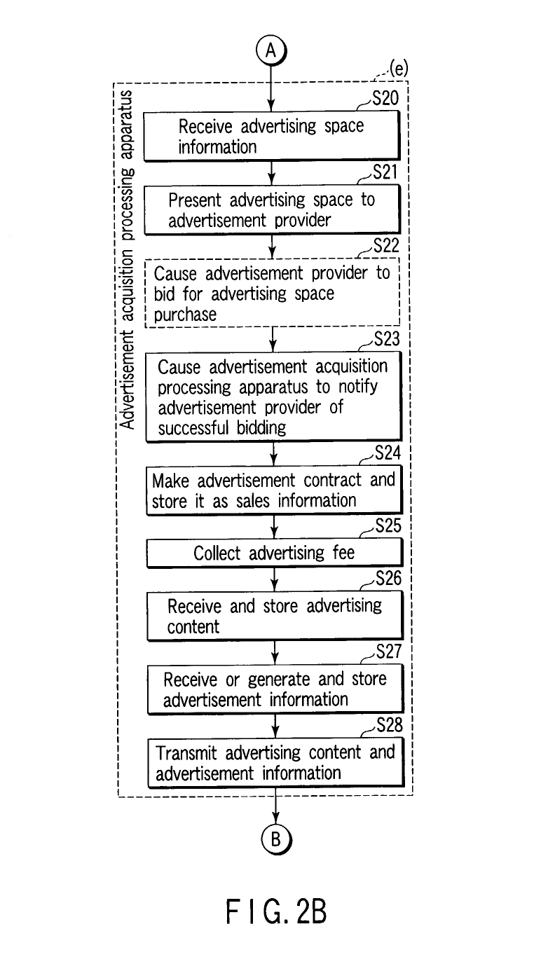

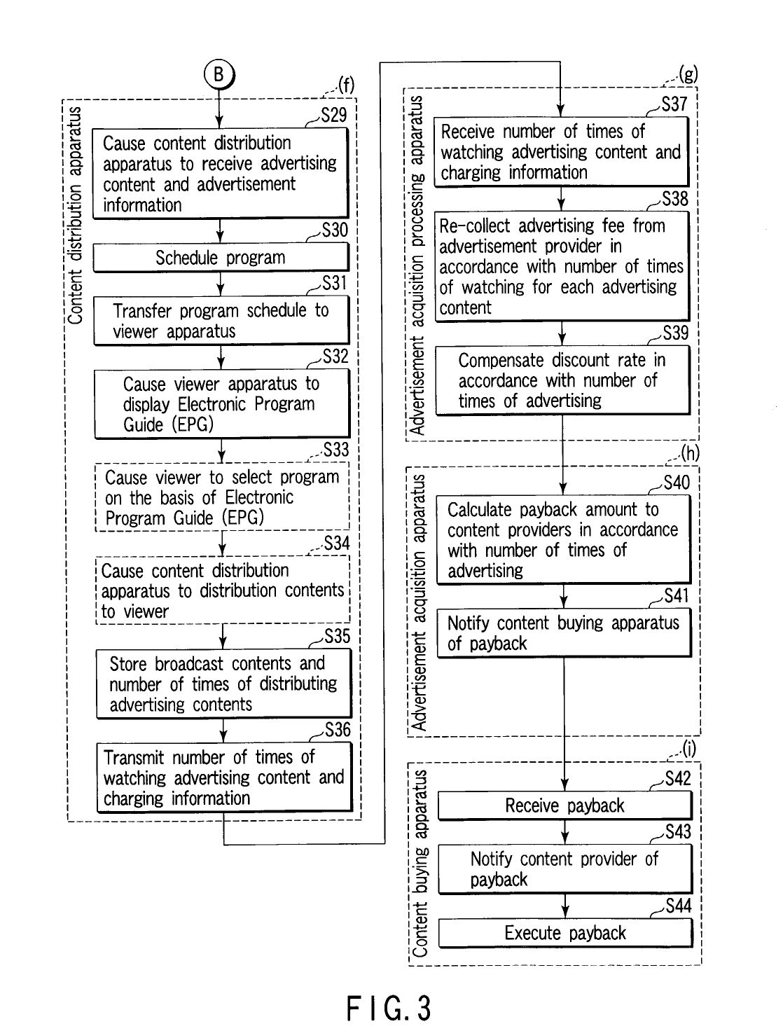

### II. Processing Operation of Electronic Merchandise Distribution System and Electronic Merchandise Distribution Method According to Embodiment of Present Invention (FIGS. 2A, 2B and 3)

(a) Collection of Global Content Watching Information by Viewer Apparatus 2

The viewer apparatus 2 accesses a video-related portal site on the Internet apparatus 1 on the basis of the URL (S1) and watches global contents distributed on the Internet apparatus 1. At this time, the viewer apparatus 2 that displays a streaming image collects and stores watching information (global content watching information) containing the name of watched contents, the access destinations for content watching, the watching times, and the watching prices (S2). The pieces of stored global content watching information are transmitted to the content evaluation apparatus 100 (S3).

(b) Extraction of Excellent Content by Content Evaluation Apparatus 100

The content evaluation apparatus 100 receives the global content watching information from the viewer apparatus 2 (S4) and accumulates the watching information (S5). The content evaluation apparatus 100 extracts excellent contents by executing predetermined evaluation/analysis for the accumulated global content watching information in consideration of the current strategy of the operator that manages the electronic merchandise distribution system 3 and, for example, a strategy for promoting acquisition of action contents (S6). After extraction of the excellent contents, the content evaluation apparatus 100 transmits the contents and content information containing content titles and access destinations to the content buying apparatus 200 (S7).

Upon receiving a content evaluation/analysis request from the content buying apparatus 200 for buying processing, the content evaluation apparatus 100 analyzes/evaluates the global contents, selects excellent contents, and transmits the content information of the excellent contents to the content buying apparatus 200.

(c) Content Buying and Content Acquisition by Content Buying Apparatus 200

After receiving content information (S8), the content buying apparatus 200 calculates an appropriate original purchase price to purchase the contents and accesses the content providing apparatus 4 (S9). The content buying apparatus 200 changes the purchase price while negotiating with the content providing apparatus 4 on the basis of the original purchase price in consideration of conditions such as the right to secondary use and the presence/absence of advertisements, makes a contract, and buys the contents (S10). After content buying, the content buying apparatus 200 acquires the contents and content purchase (contract) conditions from the content providing apparatus 4 and stores them in the storage management processing section 500 (S11 and S12). In addition, the content buying apparatus 200 acquires content information (content metainformation) from the content providing apparatus 4 or generates the content information of the contents after content buying on the basis of the content information received from the content evaluation apparatus 100 and stores the information in the storage management processing section 500 (S13). The content buying apparatus 200 also transmits the bought contents to be distributed and their content information to the content distribution apparatus 300 (S14 and S15).

(d) Generation of Temporary Program Schedule and Advertising Space Information by Content Distribution Apparatus 300

The content distribution apparatus 300 receives the contents to be distributed and content information from the content buying apparatus 200 (S16 and S17) and stores and manages them in the storage management processing section 500. After storing the contents and content information in the storage management processing section 500, the content distribution apparatus 300 classifies the contents into contents suitable for conventional TV-type distribution (push distribution) and those suitable for limited viewer distribution (pull distribution) based on selection of the viewer himself/herself in accordance with the type of contents. In addition, the content distribution apparatus 300 makes a temporary program schedule in consideration of whether advertisements can be inserted for each content on the basis of the content information (S18). As a result of temporary program schedule, advertising spaces become clear. The advertising space information is stored and managed in the storage management processing section 500 and also transmitted to the advertisement acquisition processing apparatus 400 (S19).

(e) Sales of Advertising Space and Acquisition of Advertising Content by Advertisement Acquisition Processing Apparatus 400

Upon receiving the advertising space information from the content distribution apparatus 300 (S20), the advertisement acquisition processing apparatus 400 discloses the advertising space information to the advertisement providing apparatus 5 (S21) to notify it that the advertisement acquisition processing apparatus 400 can sell advertising spaces by bid or simple sales by presenting prices. The advertisement provider who holds the advertisement providing apparatus 5 refers to the past watching statistical information (statistical information for each age or sex or statistics of distribution advertisements) of the desired advertising spaces and bids for the advertising spaces (S22). After the bidding period, the advertisement acquisition processing apparatus 400 notifies the highest bidder of the successful bid (S23), makes an advertisement contract under clear advertisement distribution conditions (e.g., the distribution time limit), and stores the contract as sales information (S24). After the contract is made, the advertisement acquisition processing apparatus 400 collects the advertising fee (S25), receives and acquires the advertising contents (S26), and stores and manages them in the storage management processing section 500. In addition, the advertisement acquisition processing apparatus 400 receives advertising content information (advertising content metainformation) from the advertisement providing apparatus 5 or generates advertising content information (S27). The advertisement acquisition processing apparatus 400 also transmits the advertising contents and advertising content information to the content distribution apparatus 300 (S28).

(f) Program Schedule and Distribution to Viewer Apparatus 2 by Content Distribution Apparatus 300

Upon receiving the advertising contents and advertising content information (S29), the content distribution apparatus 300 progresses program scheduling in accordance with the temporary program schedule generated in advance (S30). If a wait time for the viewer is generated due to an unsold advertising space or, e.g., the cue time of contents, the content distribution apparatus 300 inserts advertisements (to be referred to as dynamic advertisements hereinafter) by referring to target customer information in the advertising content information and watching information collected from the viewer. When program scheduling is ended, electronic program guide EPG is transmitted to the viewer apparatus 2 (S31) and displayed (S32), thereby giving the right of program (channel) choice to the viewer. When the viewer selects a program in accordance with the electronic program selection information (S33), the content distribution apparatus 300 distributes the content with advertisements inserted thereto to the viewer apparatus 2 (S34). In watching programs, for example, programs (TV type or VOD) having advertisements are provided at a discount as compared to programs without advertisements.

The content distribution apparatus 300 stores the number of times of distribution of each content and advertising content (S35) and transmits the number of times of distribution, distribution information, and each billing information to the advertisement acquisition processing apparatus 400 (S36).

(g) Re-Collection of Advertising Fee and Compensation of Discount Rate by Advertisement Acquisition Processing Apparatus 400

The advertisement acquisition processing apparatus 400 receives the number of distribution and distribution information of each advertising content (S37). After confirming that the advertising content is appropriately distributed in accordance with the target customer information, the advertisement acquisition processing apparatus 400 re-collects the advertising fee from the advertisement provider (S38). Part of the re-collected advertising fee is used to compensate for the discount rate for the viewer who has watched the content distribution with the advertisement (S39). For the content providing apparatus 4, i.e., the content provider who has provided the content distribution with the advertisement, a payback corresponding to the number of times of advertisement is calculated, and another part of the re-collected advertising fee is paid back to the content providing apparatus 4 (S40). The payback information is sent to the content buying apparatus 200 (S41).

(h) Payback to Content Provider by Content Buying Apparatus 200

Upon receiving the payback information (S42), the content buying apparatus 200 notifies the content providing apparatus 4 of the payback (S43) and actually executes payback (S44).

### III. Business Model by Content with Advertisement

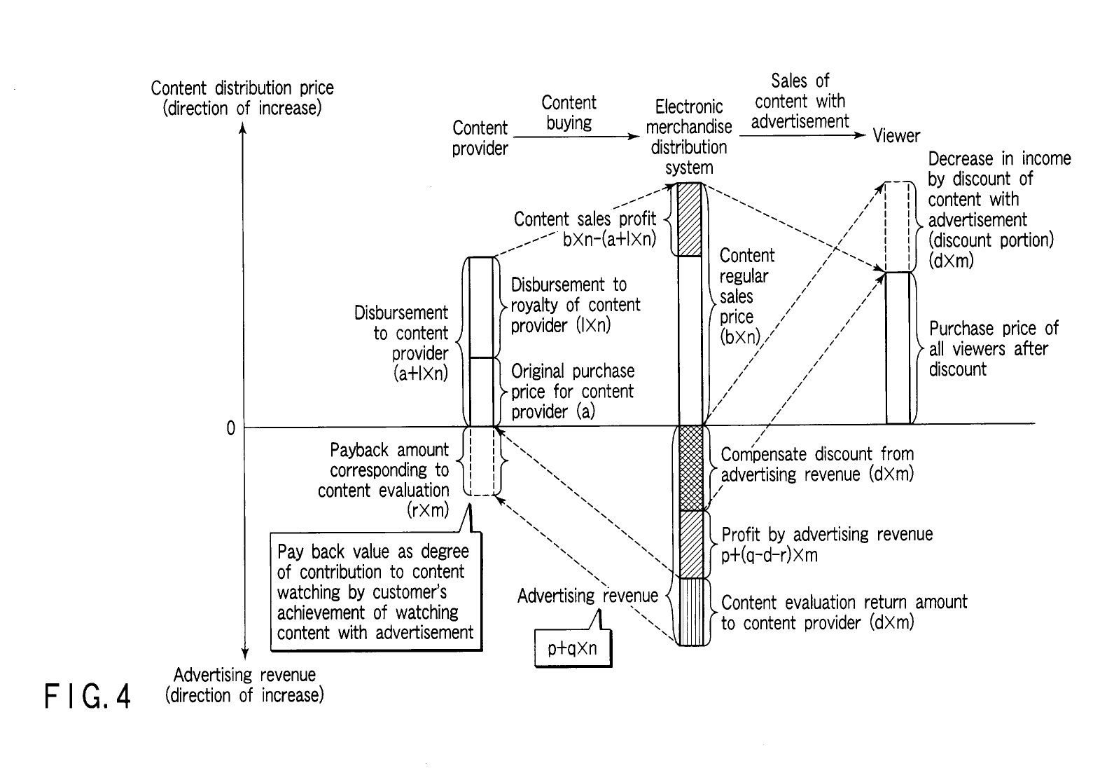

A business model by sales of contents with advertisements viewed from the electronic merchandise distribution system according to the present invention will be described with reference to FIG. 4.

Conventionally, the income and expenditure of a content distribution agent can simply be represented by the purchase prices of contents (a), the distribution prices to end users (b), the royalty to copyrighter per content (l), and the number of times of watching (n) when the manufacturing fixed cost such as the facility cost and personnel expenses are neglected. That is,

Profit for distribution service provider by content

sales=(b×n)−(a+1×n)

Conventionally, to promote content watching of viewers, the promotion expenses are obtained from the profit, or the price b or the like is reduced for a discount. Generally, contents are sold, though the revenue decreases.

To the contrary, in the embodiment of the present invention, part of the content advertisement fee is used as follows.

(1) A content with advertisements is distributed to the viewer at a discount. The discount rate is used as a compensation.

(2) It is supposed that the degree of excellence of a content has contributed to watching of the content with advertisements. Hence, payback is done for the content provider in accordance with the number of times of distribution of advertisements accompanying the content provided by the content provider.

The revenue by each advertisement contains the advertising fee (p) by sales of an advertising space and the re-collected advertising fee by a dynamic advertisement (q×m). Note that q is determined by the agent, and m is the number of times of distribution of an advertisement.

The discount (d×m) by the advertisement for the viewer and the payback (r×m) for the content provider are taken into consideration. The profit of the advertisement model is given by

Profit by advertisement=p+q×m−(d+r)×m=P+(q−d−r)×m

Hence, the profit of the entire service is given by

$$\begin{matrix}Profit = \{ profit by content sales \} + \{ profit by advertisement \} \\ = \{ b \times n - ( a + 1 \times n ) \} + \{ p + ( q - d - r ) \times m \} \\ = \{ b \times n - d \times m : revenue from end user ) - \{ a + 1 \times n + r \times m : payment to content \\ provider ) + ( p + q \times m : revenue by advertisement )\end{matrix}$$

FIG. 4 shows a model of sales of contents with advertisements and how to share the above-described profit between the content provider, the electronic merchandise distribution system, and the viewer. The bar graph on the left side of FIG. 4 indicates the revenue of the content provider. The payback revenue by advertisements adds (r×m) to the conventional disbursement (a+l×n) to the content provider.

The bar graph at the center of FIG. 4 indicates the income/expenditure system related to the electronic merchandise distribution system. The upper hatched portion b×n−(a+l×n) corresponds to the profit by content sales. The lower hatched portion p+(q−d−r)×m corresponds to the profit by advertising revenue.

The bar graph on the right side indicates the watching fee of all the viewers, which is normally b×n, though the fee is reduced by d×m in the present invention.

Consequently, when the advertising fee is reasonably used, the three parties can obtain the profit.

The content buying apparatus 200, content evaluation apparatus 100, content distribution apparatus 300, and advertisement acquisition processing apparatus 400, which construct the electronic merchandise distribution system (FIG. 1), will be individually described next in this order. The following explanation will be done while exemplifying a case wherein to buy contents, the content buying apparatus 200 requests the content evaluation apparatus 100 to evaluate/analyze contents.

### IV. Content Buying Apparatus 200

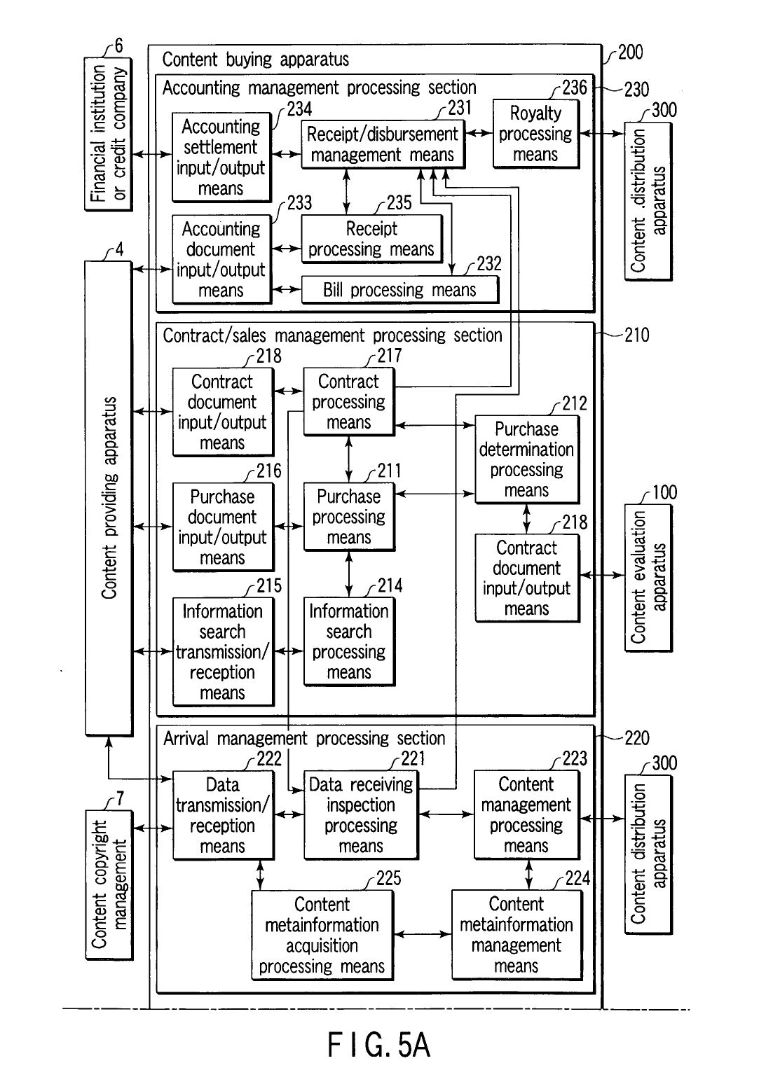

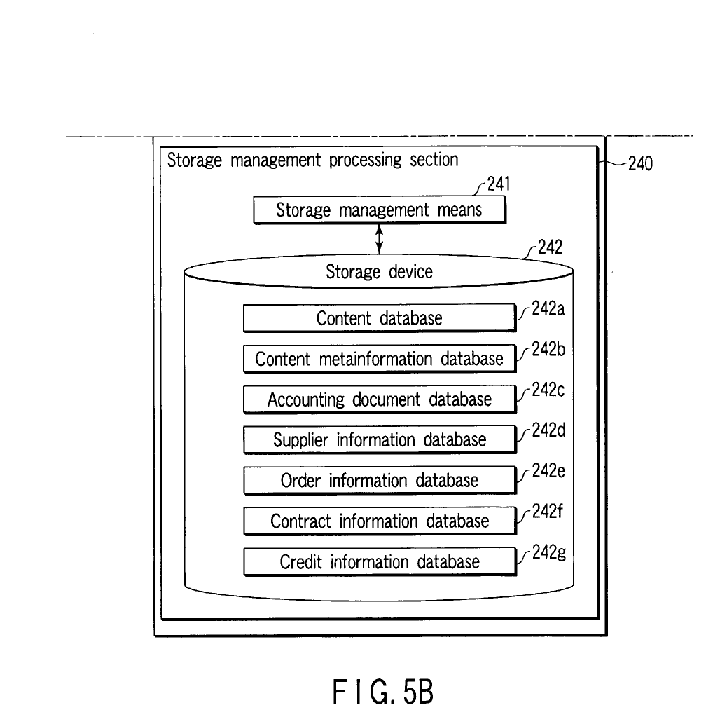

FIGS. 5A and 5B are block diagrams showing an embodiment of the content buying apparatus 200.

The content buying apparatus 200 has a function of transmitting a content buying request to the content evaluation apparatus 100 under required content buying conditions, receiving an evaluation/analysis result containing the content information of excellent contents from the content evaluation apparatus 100, and executing content buying processing between the content buying apparatus 200 and the content providing apparatus 4 as a content provider.

The content buying apparatus 200 is constituted by, e.g., a contract/sales management processing section 210, arrival management processing section 220, accounting management processing section 230, and storage management processing section 240.

The contract/sales management processing section 210 requests information necessary for content buying processing of the content evaluation apparatus 100, and on the basis of the information acquired from the content evaluation apparatus 100 and information stored in the data storage device in advance, decides the content purchase price in accordance with a predetermined purchase content price deciding scheme. The contract/sales management processing section 210 also has a function of, after deciding the content purchase price, searching for the content supplier (seller), creating order data from the content information (content metainformation) of the found content supplier, presenting the data to the content buying apparatus 200, making a contract at an appropriate content purchase price, and outputting the contract conclusion information.

Upon receiving the contract conclusion information, the arrival management processing section 220 receives contents and content metainformation from the content providing apparatus 4, checks errors in the contents and content metainformation, and confirms their contents. The contract/sales management processing section 210 stores appropriate contents and content metainformation in the storage management processing section 240 and also sends receiving inspection information to the accounting management processing section 230.

The arrival management processing section 220 also has a function of acquiring a unique content copyright ID from the terminal 7 held by the content copyright information management institute, embedding the ID in the content metainformation, and updating the content metainformation stored in the storage management processing section 240.

The accounting management processing section 230 has a function of, upon receiving the contract conclusion information from the contract/sales management processing section 210 or the receiving inspection information from the arrival management processing section 220, executing accounting settlement processing with respect to the terminal 6 held by the financial institution or credit company on the basis of the bill data from the content providing apparatus 4.

The storage management processing section 240 has a storage management means 241 for receiving a data storage request from the contract/sales management processing section 210, arrival management processing section 220 or accounting management processing section 230 and executing write and read processing corresponding to the request contents, and a storage device 242 which stores various kinds of data on the basis of an instruction from the storage management means 241.

Processing of the content buying apparatus 200 will be described next with reference to FIG. 6.

1) Content Purchase Condition Setting Processing (S201)

In content buying processing, a purchase processing means 211 of the contract/sales management processing section 210 decides the purchase price serving as a base for contents using a purchase content price deciding scheme A1 (to be described later). Various kinds of information to decide the original purchase price are stored in the storage device 242 of the storage management processing section 240. In addition, evaluation information by the content evaluation apparatus 100 and, for example, information about content sales achievement evaluation A2 (to be described later) is necessary.

The purchase processing means 211 reads out, from the storage device 242 of the storage management processing section 240, the following parameter information to decide the content purchase price by the purchase content price deciding scheme and sets the parameters in a purchase determination processing means 212.

In the set information, pieces of parameter information with few variation elements, such as the content sales price to customers, content royalty price, manufacturing fixed cost (depreciation) of the electronic merchandise distribution system facility, and the management cost of the electronic merchandise distribution system facility are set as specified values.

2) Purchase Determination Information Acquisition Processing (S202)

Upon receiving the parameter information necessary for the purchase content price deciding scheme A1 from the purchase processing means 211, the purchase determination processing means 212 requests an evaluation/analysis management processing section 110 of the content evaluation apparatus 100 to provide information about the sales achievement evaluation A2 through a statistical data acquisition means 213.

The purchase determination processing means 212 receives information about the sales achievement evaluation A2 from a data report processing section 140 of the content evaluation apparatus 100. Then, the purchase determination processing means 212 transmits, to the evaluation/analysis management processing section 110 of the content evaluation apparatus 100 through the statistical data acquisition means 213, information about “genre tendency” of the sales achievement evaluation A2 as a parameter to calculate the “expected number of contents to be sold”.

Upon receiving the information of the “expected number of contents to be sold” acquired from the data report processing section 140 of the content evaluation apparatus 100, the purchase determination processing means 212 decides the content purchase price for each “genre tendency” by the purchase content price deciding scheme A1 on the basis of the acquired information and the information to decide the content purchase price, which is stored in the storage device 242.

<Purchase Content Price Deciding Scheme A1>

A) Decision of Content Original Purchase Price

For the original purchase price of a content, the expected amount of sales is calculated on the basis of the sales price decided by the electronic merchandise distribution system and the “expected number of contents to be sold”. In addition, a material cost (content purchase price) as a variable cost is calculated on the basis of the expected amount of sales. The expected amount of sales contains the initial cost (sales cost) for content distribution and sales profit. The sales profit (particularly, operating profit) set by the electronic merchandise distribution system 3 is used as the parameter of content original purchase price.

$$\begin{matrix}Expected amount of sales = sales price \times expected number of contents to be sold \\ = sales cost + sales profit \\ = merchandise sales cost + manufacturing variable cost + \\ manufacturing fixed cost + gross profit on sales \\ Merchandise sales cost = management cost of content distribution facility \\ Manufacturing variable cost = royalty price of content \times expected number of contents to be \\ sold + basic purchase price of content + content distribution \\ cost \times expected number of contents to be sold \\ Manfacturing fixed cost = depreciation of electronic merchandise distribution system \\ facility \\ Gross profit on sales = expense for sales + operating profit of electronic merchandise \\ distribution system\end{matrix}$$

Hence, the original purchase price of contents=expected number of contents to be sold−(merchandise sales cost+manufacturing fixed cost+gross profit on sales)−(royalty price of content×expected number of contents to be sold+content distribution cost×expected number of contents to be sold).

B) Calculation of Purchase Price Considering Content Evaluation

When contents should be purchased from the content providing apparatus 4 serving as a content provider, an evaluation value for purchase estimation is calculated from content sales information or system management information that the electronic merchandise distribution system 3 have collected from the viewer apparatus 2 is calculated and reflected on the original purchase price. The content sales information corresponds to the number of times of content watching of the viewer of the viewer apparatus 2. Hence, for example, the total number of times of movie watching is used as the number of times of content sales. In addition, the average value of the numbers of times of sales of movies in a specific genre is used as the expected number of contents to be sold in that genre.

Evaluation is done in, e.g., five ratings (−2, −1, 0, 1, 2) for each item of the sales achievement evaluation A2 for each content. Evaluation values are calculated from information of all sales contents, and their average value is “0” in the 5-rating evaluation. The evaluation of a content to be purchased has, e.g., five items each of which is compared with the average value, thereby deciding the evaluation rating. The final evaluation rating is calculated from the average value of the five items.

Final purchase price=original purchase price of content+(reference price based on predetermined operating profit as funds)×evaluation rating

As the reference price value based on the predetermined operating profit as funds, the “evaluation amount (reference price value) to be added” is decided at the time of content purchase on the basis of the funds, i.e., the operating profit in the gross profit on sales of the profit of content sales. The actual price is a specified value decided by the operating side on the basis of the operating profit.

<Sales Achievement Evaluation A2>: Five Ratings (a through e)

a) Sales Achievement of Contents

Contents with high sales achievement are evaluated high. The sales achievement equals the distribution achievement of contents. The sales achievement is determined also in consideration of the audience ratings of contents or the continuous watching time of viewers.

b) Genre Tendency

When the sales achievement of contents of a specific genre is high, contents of that genre are evaluated high.

c) Content Provider

Content providers that provide contents with high sales achievement are evaluated high. This is because the contents themselves have big brand-names.

d) Gross Margin

The gross margin of contents is calculated from the content sales achievement. Contents with a high gross margin are evaluated high. The evaluation is also done on the basis of the ratio of the gross margin when the contents are sold at the list price to that when the contents are sold at a discount.

e) Cost

The cost is evaluated in consideration of the distribution cost such as line expenses in distributing contents to customers, the sales cost for sales promotion, and the like. The cost is also evaluated on the basis of expenses for maintaining contents.

The purchase determination processing means 212 decides the content purchase price for each “genre tendency” in the above-described manner and notifies the purchase processing means 211 of the purchase price.

3) Supplier Search Processing (S203)

Upon receiving the information of the content purchase price decided for each “genre tendency”, the purchase processing means 211 searches for a supplier from a supplier information database 242d which is one of databases in the storage device 242 using the storage management means 241 of the storage management processing section 240.

Before searching for a content provider as a supplier (seller) of contents, i.e., the content providing apparatus 4, the following information storage processing is executed in advance.

Pieces of company information of content providers are acquired from the search information site of the Internet or the like and stored in the supplier information database 242d through the storage management means 241 in advance. In addition, credit information for accounting settlement is also acquired and stored in a credit information database 242g.

Hence, the purchase processing means 211 searches for a supplier from the supplier information database 242d through the storage management means 241 and acquires information (e.g., information such as a URL necessary for network communication) necessary for access to the content providing apparatus 4.

The purchase processing means 211 determines whether a supplier that meets supplier purchase conditions is present (S204). If no information about the corresponding content providing apparatus 4 is present, content buying processing is ended (S205).

4) Content Search Processing (S206)

The purchase processing means 211 searches for the information of the content providing apparatus 4 as a supplier in steps S203 and S204 and instructs an information search processing means 214 to acquire content metainformation (content information) held by the content providing apparatus 4.

The information search processing means 214 searches for content metainformation of the content providing apparatus 4 through an information search transmission/reception means 215. The information search transmission/reception means 215 executes transmission/reception data format conversion and communication processing for the content providing apparatus 4 on the basis of an electronic information interchange (EDI (Electronic Data Interchange), ebXML, or HTTP) protocol. Examples of information contained in the content metainformation are a content code (content copyright ID), video format, content time, author, date/time of creation, copyrighter, compression CODEC, content hash value, content storage destination address, use conditions (distribution time limit, right to alteration, right to secondary use, right to sales, and the like), royalty information (royalty price, payment conditions, contract period), an advertisement insertion condition (insertion of video advertisement, insertion of banner advertising (billboard advertisement displayed on a web page), or the like). Even when the number of information is less than above, it poses no serious problem for content buying.

When the information search processing means 214 acquires content metainformation as a search result using the information search transmission/reception means 215, the content metainformation is stored in a content metainformation database 242b through the storage management means 241 and also sent to the purchase processing means 211. The purchase processing means 211 compares the sales achievement evaluation A2 acquired in step S202 with the content metainformation acquired from the content providing apparatus 4 (S207) and selects contents to be bought. If no contents satisfy the conditions, content buying processing is ended (S205).

5) Buying Estimation Processing (S208)

The purchase processing means 211 transmits order data to the content providing apparatus 4 through a purchase document input means 216 on the basis of the content metainformation selected in step S206 and stores the order data in an order information database 242e through the storage management means 241. The purchase document input means 216 executes transmission/reception data format conversion and communication processing for the content providing apparatus 4 on the basis of an electronic information interchange (EDI, ebXML, or HTTP) protocol.

Upon receiving a reply to the order data from the content providing apparatus 4 through the purchase document input means 216, the purchase processing means 211 compares content price information in the received reply to the order data with the content purchase price for each “genre tendency” based on the purchase content price deciding scheme A1, which is calculated in step S202 (S209). When the content price information to the order data is equal to or less than the content purchase price for each “genre tendency”, the purchase processing means 211 determines that a contract can be made.

When the purchase processing means 211 determines that a contract can be made, it updates the order data stored in the order information database 242e.

The purchase processing means 211 sends the order conclusion information of the content that is determined as buyable by a contract to a contract processing means 217. The contract processing means 217 executes purchase contract processing (S210). If the content price information in the reply to the order data is more than the content purchase price for each “genre tendency”, the purchase processing means 211 determines that no contract can be made.

For the content for which it is determined that no contract can be made, renegotiation is done while reducing the content purchase price by excluding items of sales condition evaluation A3 (to be described below) on the basis of the reply to the order data, which is presented by the content providing apparatus 4. Otherwise, the negotiation is broken off.

<Sales Condition Evaluation A3>

a) Content with Advertisements

A content with advertisements is evaluated in accordance with the advertising revenue. If advertisements can be inserted to the content, it is evaluated high.

Additional advertising revenue is obtained in accordance with the content sales achievement.

b) Right Conditions

A content that has advantageous right conditions about copyright use permission, including the right to secondary use, is evaluated high.

Contents are evaluated high for each permission condition.

Renegotiation Processing

The purchase processing means 211 sets, for the purchase determination processing means 212, items of the sales condition evaluation A3 to recalculate contents. The purchase determination processing means 212 transmits, to the content evaluation apparatus 100, the result in step S202 and the items of the sales condition evaluation A3 and instructs the content evaluation apparatus 100 to recalculate.

The content evaluation apparatus 100 evaluates content purchase price information while excluding the items of the sales condition evaluation A3 one by one and transmits the information to the purchase determination processing means 212. The purchase determination processing means 212 receives the content purchase price information obtained by excluding the items of the sales condition evaluation A3 one by one and sends the information to the purchase processing means 211. The purchase processing means 211 creates order data on the basis of the new content purchase price information sent from the purchase determination processing means 212 and transmits the order data to the content providing apparatus 4 through the purchase document input means 216, thereby executing renegotiation.

Break-Off of Negotiation

When the price in the reply to the order data, which is presented by the content providing apparatus 4, is set considerably higher than the content purchase price, the purchase processing means 211 ends content buying processing.

6) Purchase Contract Processing (S210)

When the purchase processing means 211 determines that a contract can be made, as described above, it sends content order conclusion information to the contract processing means 217. The contract processing means 217 starts purchase contract processing on the basis of the order conclusion information. The contract processing means 217 creates contract data containing the purchase price from the order data in the order information database 242e of the storage device 242 through the storage management means 241 and stores the contract data in the order information database 242e of the storage device 242. Additionally, the contract processing means 217 transmits the created contract data to the content providing apparatus 4 through a contract document input/output means 218. The contract document input/output means 218 executes transmission/reception data format conversion and communication processing for the content providing apparatus 4 on the basis of an electronic information interchange (EDI, ebXML, or HTTP) protocol.

Upon receiving a reply to the contract data, which is transmitted from the content providing apparatus 4 through the contract document input/output means 218, the contract processing means 217 confirms the reply contents. Thus, a contract is made.

The contract processing means 217 updates the contract data in a contract information database 242f through the storage management means 241 on the basis of the data of the contract made and stores the reply data to the contract data.

When a contract is made, the contract processing means 217 inputs contract conclusion information to a data receiving inspection processing means 221 of the arrival management processing section 220 and a receipt/disbursement management means 231 of the accounting management processing section 230.

7) Content Arrival Processing (S211)

Upon receiving the contract conclusion information from the contract processing means 217, the data receiving inspection processing means 221 of the arrival management processing section 220 starts content arrival processing. More specifically, the data receiving inspection processing means 221 searches for contract information stored in the contract information database 242f of the storage device 242 using the storage management means 241 on the basis of the contract conclusion information. The data receiving inspection processing means 221 also acquires content metainformation from the content metainformation database 242b of the storage device 242 through the storage management means 241.

After receiving the contract conclusion information and acquiring the content metainformation in the above-described way, the data receiving inspection processing means 221 waits for reception of a content sent from the content providing apparatus 4. Upon receiving the content and content metainformation from the content providing apparatus 4 through a data transmission/reception means 222, the data receiving inspection processing means 221 executes conformation processing such as redundancy check or check sum to check errors in the received data. If the data have no errors, the content metainformation received from the content providing apparatus 4 is compared with the content metainformation stored in the content metainformation database 242b of the storage device 242 to conform the contents.

After confirming the content and the contents of the content metainformation, the data receiving inspection processing means 221 stores the received content metainformation in the content metainformation database 242b of the storage device 242 and the received content in a content database 242a. The data receiving inspection processing means 221 also sends receiving inspection information to the receipt/disbursement management means 231 of the accounting management processing section 230.

After confirming the content and the contents of the content metainformation, the data receiving inspection processing means 221 sends a notification to a content management processing means 223 to notify it that the content and content metainformation are updated.

The content management processing means 223 requests a content metainformation management means 224 to create content metainformation to be used by the electronic merchandise distribution system 3. The content metainformation management means 224 acquires a unique content copyright ID from the terminal 7 held by the content copyright information management institute through a content metainformation acquisition processing means 225.

The content metainformation management means 224 acquires the content metainformation stored in the content metainformation database 242b of the storage device 242 using the storage management means 241 and sends the content metainformation to the data receiving inspection processing means 221. The data receiving inspection processing means 221 writes the unique content copyright ID in the content metainformation, thereby updating the content metainformation. The data receiving inspection processing means 221 stores the content metainformation in the content metainformation database 242b of the storage device 242 using the storage management means 241.

8) Purchase Bill Processing (S212)

The receipt/disbursement management means 231 of the accounting management processing section 230 receives the contract conclusion information from the contract processing means 217 and receiving inspection information from the data receiving inspection processing means 221 and then starts purchase bill processing. More specifically, after receiving the contract conclusion information and receiving inspection information, the receipt/disbursement management means 231 waits until bill data reception from the content providing apparatus 4.

At this time, upon receiving bill data through an accounting document input/output means 233, a bill processing means 232 notifies the receipt/disbursement management means 231 of reception of the bill data.

The receipt/disbursement management means 231 confirms the contents of the bill data on the basis of the contract conclusion information and receiving inspection information. If the contents are correct, the receipt/disbursement management means 231 stores the bill data in an accounting document database 242c of the storage device 242 using the storage management means 241. In addition, the receipt/disbursement management means 231 executes receipt processing for the terminal 6 held by a financial institution or credit company through an accounting settlement input/output means 234 on the basis of the contents of the bill data.

The accounting settlement input/output means 234 executes transmission/reception data format conversion and communication processing for the terminal 6 held by a financial institution or credit company on the basis of an electronic information interchange (EDI, ebXML, or HTTP) protocol. After receipt, the receipt/disbursement management means 231 creates receipt data and sends it to a receipt processing means 235.

The receipt processing means 235 executes transmission/reception data format conversion and communication processing for the content providing apparatus 4 on the basis of an electronic information interchange (EDI, ebXML, or HTTP) protocol. On the other hand, the receipt/disbursement management means 231 stores the receipt data in the accounting document database 242c of the storage device 242 using the storage management means 241.

The receipt/disbursement management means 231 receives payback information from an advertisement purchase section 410 and starts payback disbursement processing. In this payback processing, when the bill processing means 232 receives bill data through the accounting document input/output means 233 and notifies the receipt/disbursement management means 231 of reception of the bill data in bill processing, the receipt/disbursement management means 231 adds the payback amount to the contents of the bill data and executes disbursement processing to the terminal 6 held by a financial institution or credit company.

According to the embodiment of the content buying apparatus 200 with the above arrangement, in buying a content, a content purchase price is decided on the basis of the evaluation/analysis result from the content evaluation apparatus 100, information about sales achievement evaluation is acquired from the content evaluation apparatus 100, and the final content purchase price is decided. A supplier stored in advance is searched for, and order data is transmitted to the supplier. When both parties agree with the price, a content purchase contract is made. This can contribute to promoting supply of excellent contents.

### V. Content Evaluation Apparatus 100

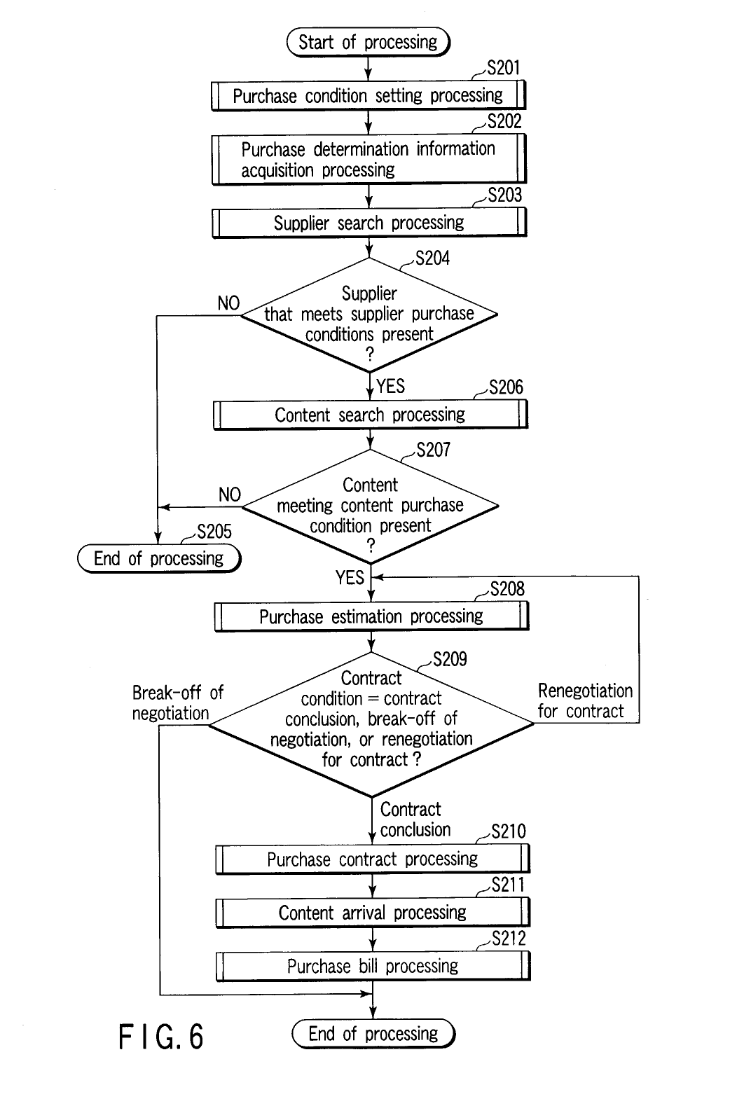

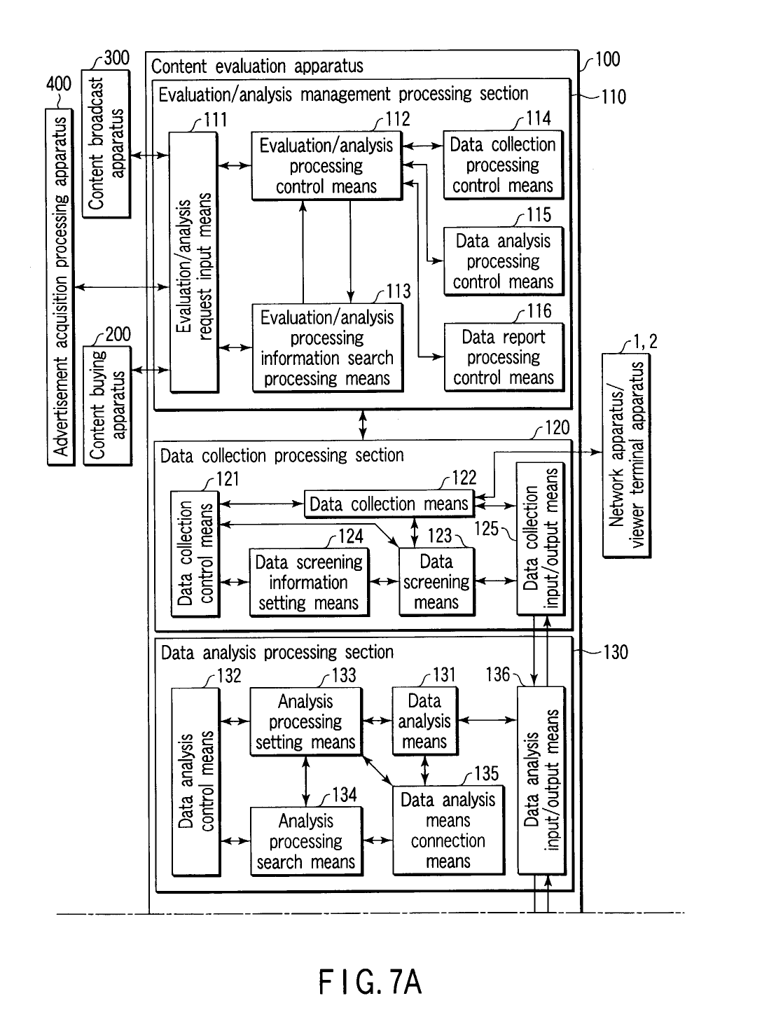

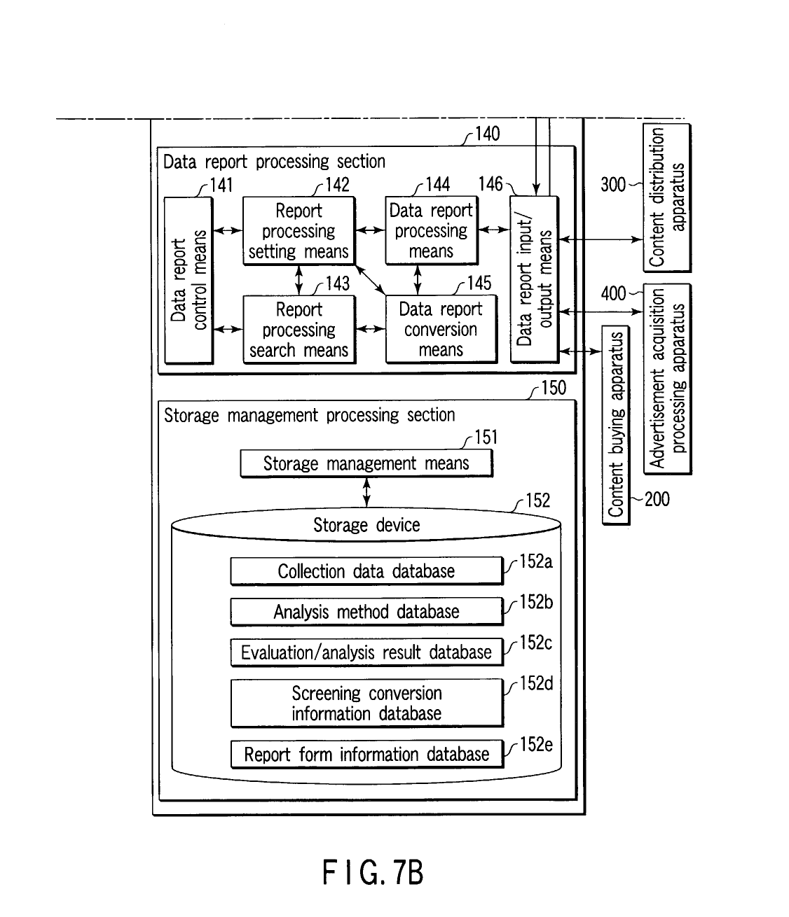

FIGS. 7A and 7B are block diagrams showing an embodiment of the content evaluation apparatus 100.

The content evaluation apparatus 100 comprises, e.g., an evaluation/analysis management processing section 110, data collection processing section 120, data analysis processing section 130, data report processing section 140, and storage management processing section 150.

The evaluation/analysis management processing section 110 receives an evaluation/analysis request from the apparatuses 200 through 400, sets pieces of information related to evaluation items, evaluation method, screening conversion information, and the report form corresponding to the contents of the received request to the corresponding data collection processing section 120, data analysis processing section 130, data report processing section 140, and the like, and generates an evaluation/analysis processing start instruction.

The data collection processing section 120 collects data from necessary processing sections and means in the network apparatus 1, viewer apparatus 2, and system in accordance with the evaluation items in the evaluation items and screening conversion information set from the evaluation/analysis management processing section 110. The data collection processing section 120 also searches the storage management processing section 150 for a screening conversion information processing method in accordance with the screening conversion information as processing information. The data collection processing section 120 has a function of selecting necessary data from the collected data on the basis of the screening conversion information processing method and creating result data.

The data analysis processing section 130 has a function of, when the evaluation/analysis management processing section 110 sets the evaluation method, searching the storage management processing section 150 for a processing method for the evaluation method, setting a processible state in accordance with the processing method, and creating data processed in accordance with the processing method (processing algorithm) for the evaluation method, which is searched for on the basis of the result data created by the data collection processing section 120.

The data report processing section 140 has a function of, when a report form is set from the evaluation/analysis management processing section 110, searching the storage management processing section 150 for a processing method for the report form, setting a processible state in accordance with the processing method, creating a report form for the data created by the data report processing section 140 in accordance with the processing method for the report form, and transmitting the report form to the evaluation/analysis request destination.

The storage management processing section 150 has a storage management means 151 for executing data read and data write processing in accordance with requests from the processing sections 100 through 140, and a storage device 152. The storage device 152 has a collection database 152a which stores data collected from the storage monument network apparatus 1 or viewer apparatus 2 and data of necessary processing result of the content evaluation system 100, an analysis method database 152b which stores data related to analysis methods, an evaluation/analysis result database 152c which stores data related to evaluation/analysis results, a screening conversion information database 152d which stores screening conversion information, and a report form information database 152e which stores report form data.

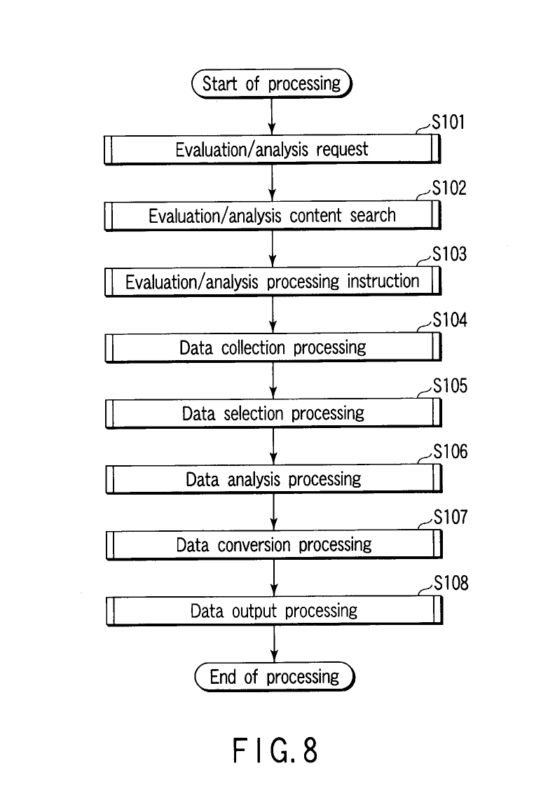

Processing by the content evaluation apparatus 100 will be described next with reference to FIG. 8.

1) Evaluation/Analysis Request (S101)

An evaluation/analysis request input means 111 of the evaluation/analysis management processing section 110 has a data manipulation language or language application interface. The evaluation/analysis request input means 111 receives an evaluation/analysis request from the content buying apparatus 200, content distribution apparatus 300, or advertisement acquisition processing apparatus 400 and notifies an evaluation/analysis processing control means 112 of it.

2) Evaluation/Analysis Content Search (S102)

The evaluation/analysis processing control means 112 confirms the contents of the evaluation/analysis request received from the evaluation/analysis request input means 111. If the confirmation reveals that any one of the request items (evaluation method, evaluation item, report form, and screening conversion information) of the evaluation/analysis is information that designates an item already registered in the analysis method database 152b as part of the storage device 152 of the storage management processing section 150, the evaluation/analysis processing control means 112 notifies an evaluation/analysis information search processing means 113 of the information search request. The evaluation/analysis information search processing means 113 searches the analysis method database 152b of the storage device 152 using the storage management means 151 and sends the search result to the evaluation/analysis processing control means 112.

The request items of evaluation/analysis include the following evaluation methods, evaluation items, report forms, and screening conversion information.

a) Evaluation Method

Evaluation methods include the following evaluation/analysis methods.

Simple linear regression analysis, multiple linear regression analysis, and principal component analysis

Sales achievement: ABC analysis and category analysis

When such an evaluation method is used, sales analysis, content analysis, advertisement analysis, customer analysis, sales promotion effect analysis can be performed.

For evaluation/analysis, one of the above established evaluation methods or an evaluation method registered in the storage device 152 in advance is used.

b) Evaluation Item

For the evaluation items, information externally defined on the system is given. In addition, information related to the evaluation items, which is registered in the analysis method database 152b of the storage device 152, is used.

Examples of the evaluation items are analysis items.

Sales analysis

Of information necessary for sales analysis, information collectable from the navigation system of the viewer apparatus 2

Merchandise (content), merchandise code (content code), merchandise type (genre), merchandise name, number of merchandise sold, time, customer code, maker name (content provider), content royalty, and discount price (actual sales price)

Maker name (content provider), customer code, customer name, address, credit information, and content information (content metainformation)

Of information necessary for sales analysis, information collectable from the network apparatus 1

Communication carrier (customer code, customer name, credit information, network information, and service information) and other information related to general customers

Of information necessary for sales analysis, information held by the electronic merchandise distribution system 3 itself in advance

Information related to depreciation

Information related to the income statement

Information related to the break-even point

Information related to sales

Information related to advertising sales

Content analysis

Of information necessary for content analysis, information collectable from the navigation system of the viewer apparatus 2

Merchandise (content) information, merchandise code (content code), merchandise type (genre), merchandise name, number of merchandise sold, time, customer code, maker name (content provider), and discount price (actual sales price)

Maker name (content provider), customer code, customer name, address, credit information, and content information (content metainformation)

Of information necessary for content analysis, information collectable from the network apparatus 1

Communication carrier (customer code, customer name, credit information, network information, and service information)

Information related to general customers

Information related to distribution cost

Of information necessary for content analysis, information collectable from the playback device or navigation system of the viewer apparatus 2

Information related to audience rating

Advertisement analysis, customer analysis, sales promotion effect analysis, and the like are also present.

c) Report Form

This means a report form of information evaluated/analyzed by the evaluation method and is stored in the analysis method database 152b of the storage device 152 in advance. Report forms are classified into, e.g., a format form and format conversion information. As format forms, an application interface format, book and accounting document forms, and book and accounting document formats are defined. As format conversion information, data form change, data visualization/graph conversion, and the like are defined.

d) Screening Conversion Information

The screening conversion information indicates the followings.

Filter item: items to be filtered are designated from the evaluation items.

Conversion algorithm

Designated data is replaced with random data.

Designated data is replaced with null data.

Designated data is replaced with specific data.

Specific data is inserted into part of designated data.

The above evaluation methods, evaluation items, screening conversion information, report forms, and the like are registered in the analysis method database 152b, selection information database 152d, report format information database 152e, and the like of the storage device 152 and used particularly by the data analysis means 131 of the data analysis processing section 130 for evaluation/analysis when an evaluation/analysis request is received from the apparatuses 200 through 400.

3) Evaluation/Analysis Processing Instruction (S103)

In step S102, the evaluation/analysis information search processing means 113 searches the analysis method database 152b of the storage device 152 in accordance with the evaluation/analysis request items and sends the search result to the evaluation/analysis processing control means 112. The evaluation/analysis processing control means 112 sets processing information (evaluation items) as the search result to a data collection control means 121 of the data collection processing section 120 through a data collection processing control means 114. The data collection control means 121 activates a data collection means 122 and sets the processing information (evaluation items).

The evaluation/analysis processing control means 112 also sets processing information (screening conversion information) as the search result to the data collection control means 121 of the data collection processing section 120 through the data collection processing control means 114. The data collection control means 121 sets the set processing information (screening conversion information) to the data collection means 122 and a data screening means 123. The data collection processing control means 114 also sets, to the data screening means 123, the evaluation items set in the data collection means 122. Hence, the data collection means 122 and data screening means 123 are in a one-to-one correspondence and may be simultaneously executed in accordance with the collection purpose.

The data screening means 123 instructs the data screening information setting means 124 to search for a processing method for processing information (screening information conversion). The data screening information setting means 124 searches the screening conversion information database 152d of the storage device 152 for the processing method (screening conversion information) using the storage management means 151 and sends the search result to the data screening means 123. The data screening means 123 sets the processing method as the search result to the evaluation/analysis processing control means 112 of the evaluation/analysis management processing section 110.

The evaluation/analysis processing control means 112 sets evaluation item information as processing information to a data analysis control means 132 of the data analysis processing section 130 through a data analysis processing control means 115. The data analysis control means 132 sets the evaluation items to an analysis processing setting means 133. The analysis processing setting means 133 instructs an analysis processing search means 134 to search for a processing method for the evaluation items.

The analysis processing search means 134 searches the analysis method database 152b of the storage device 152 for a processing method using the storage management means 151 and sends the search result to the analysis processing setting means 133.

The analysis processing setting means 133 executes the following processing in accordance with the contents of the processing method.

a) Generation of Data Analysis Means 131

The analysis processing setting means 133 generates at least one data analysis means 131. The analysis processing setting means 133 generates all necessary data analysis means 131 in accordance with the processing method.

b) Setting of Individual Processing Method for Data Analysis Means 131

The analysis processing setting means 133 sets an individual processing algorithm to the data analysis means 131.

c) In Case of Data Analysis Means 131

The analysis processing setting means 133 sets structure information of the data analysis means 131 to a data analysis means interconnection means 135 as needed. The structure information means the followings. Processing executed by the data analysis means 131 must be analyzed using a plurality of processes such as accumulation and statistical computation. Hence, the structure information is information used to execute calculation by connecting a plurality of data analysis means 131 in a predetermined order. That is, the data analysis means interconnection means 135 connects the plurality of data analysis means 131 that construct one processing method (connection of processing methods). The data analysis means interconnection means 135 also connects a data analysis input/output means 136 to the plurality of data analysis means 131 that construct one processing method (connection of data inputs/outputs).

The pieces of information of structure and connection of all the data analysis means 131, which are used to execute the above processing, are managed by the analysis processing setting means 133.

The evaluation/analysis processing control means 112 also sets processing information (report form) to a data report control means 141 of the data report processing section 140 through a data report processing control means 116. The data report control means 141 sets the processing information (report form) to a report processing setting means 142. The report processing setting means 142 instructs a report processing search means 143 to search the report form as processing information. The report processing search means 143 searches the report form information database 152e of the storage device 152 for the report form using the storage management means 151 and sends the found, e.g., format form and format conversion information to the report processing setting means 142.

The report processing setting means 142 sets the format form as the search result to a data report processing means 144 and the format conversion information to a data conversion processing means 145. The report processing setting means 142 connects the data report processing means 144 and data conversion processing means 145.

With the series of processes, the data collection processing section 120, data analysis processing section 130, and data report processing section 140 are set in a processible state.

The evaluation/analysis processing control means 112 instructs, through the data collection processing control means 114, the data collection control means 121 of the data collection processing section 120 to start processing. The data collection control means 121 instructs the data collection means 122, data screening means 123, and data collection input/output means 125 to start processing.

The evaluation/analysis processing control means 112 also instructs, through the data analysis processing control means 115, the data analysis control means 132 of the data analysis processing section 130 to start processing. The data analysis control means 132 instructs, through the analysis processing setting means 133, the data analysis means 131 and data analysis input/output means 136 to start processing.

The evaluation/analysis processing control means 112 also instructs, through the data report processing control means 116, the data report control means 141 of the data report processing section 140 to start processing. The data report control means 141 instructs, through the report processing setting means 142, the data report processing means 144 and data conversion processing means 145 to start processing.

4) Data Collection Processing (S104)

The data collection means 122 collects data according to the evaluation items from the processing sections and means in the network apparatus 1, viewer apparatus 2, and electronic merchandise distribution system 3. The interface used by the data collection means 122 to collect data is a data manipulation language, network management protocol (SNMP or OSI management), HTTP protocol, or language application interface.

5) Data Selection Processing (S105)

The data collection means 122 sends the collected data to the data screening means 123. The data screening means 123 screens and converts corresponding collection data from the collection data on the basis of screening conversion information, creates result data, and sends it to the data collection input/output means 125. The data collection input/output means 125 stores the data in the collection data database 152a of the storage device 152 using the storage management means 151.

6) Data Analysis Processing (S106)

The data analysis means 131 sends a result data acquisition request to the data collection input/output means 125 through the data analysis input/output means 136. The data collection input/output means 125 acquires the result data from the collection data database 152a of the storage device 152 using the storage management means 151 and transfers the result data to the data analysis input/output means 136. The data analysis input/output means 136 sends the result data to the data analysis means 131. The data analysis means 131 processes the received result data in accordance with the processing algorithm for the evaluation method and sends the processed data to the data analysis input/output means 136.

7) Data Conversion Processing Section (S107)

The data report processing means 144 of the data report processing section 140 outputs a processed data acquisition request to the data analysis input/output means 136 through a data report input/output means 146. The data analysis input/output means 136 sends the processed data to the data report processing means 144 through the data report input/output means 146. The data report processing means 144 inputs the received processed data to the data conversion processing means 145. The data conversion processing means 145 executes, for the report form of the received processed data, format conversion or graph conversion according to the format conversion information and sends the processing result to the data report processing means 144.

8) Data Output Processing (S108)

The data report processing means 144 executes, for the processing result received from the data conversion processing means 145, book and accounting document format insertion processing according to the format form or insertion processing to the interface form of the content buying apparatus 200, content distribution apparatus 300, and advertisement acquisition processing apparatus 400 as request destinations and creates report form data. The data report processing means 144 stores the report form data in the report form database 152e using the storage management means 151.

The data report processing means 144 also provides, through the data report input/output means 146, the report form data to the content buying apparatus 200, content distribution apparatus 300, and advertisement acquisition processing apparatus 400 as evaluation/analysis request destinations. For the evaluation/analysis response, the data report input/output means 146 uses a data manipulation language or language application interface as an interface to the content buying apparatus 200, content distribution apparatus 300, and advertisement acquisition processing apparatus 400.

According to the embodiment of the content evaluation apparatus 100 having the above arrangement, contents are evaluated/analyzed on the basis of a predetermined evaluation method and evaluation items in accordance with content evaluation/analysis contents from the content buying apparatus 200, content distribution apparatus 300, and advertisement acquisition processing apparatus 400. The evaluation/analysis result is converted into a necessary format in accordance with screening conversion information, and report data is created and transmitted to the request destination. With this arrangement, an excellent evaluation/analysis result can be provided to the request destination and used by, e.g., the content buying apparatus 200 as an effective index in buying contents from the content providing apparatus 4.

In the above-described embodiment, the content buying apparatus 200 or the like requests content evaluation/analysis. Instead, the content evaluation apparatus 100 can acquire content watching information from a number of viewer apparatuses 2 or necessary information from the network apparatus 1, evaluate the contents for each genre, select excellent contents, and present them to the content buying apparatus 200 to promote supply of contents.

### VI. Content Distribution Apparatus 300

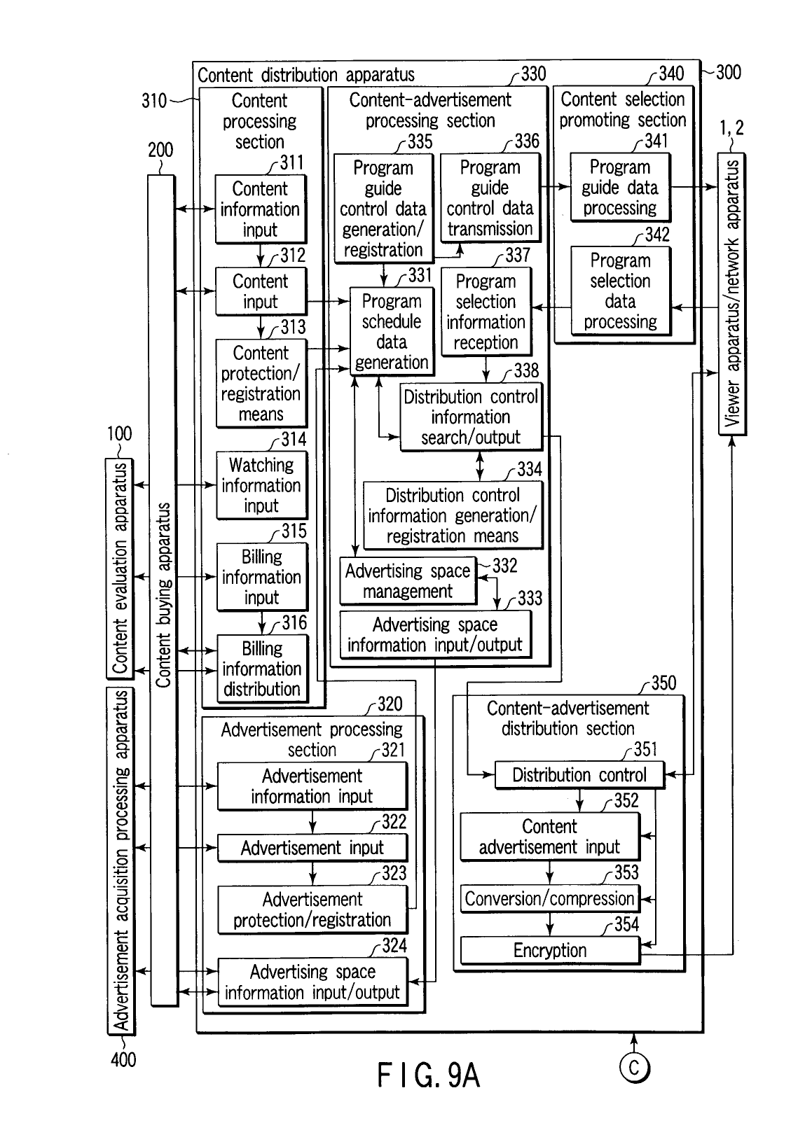

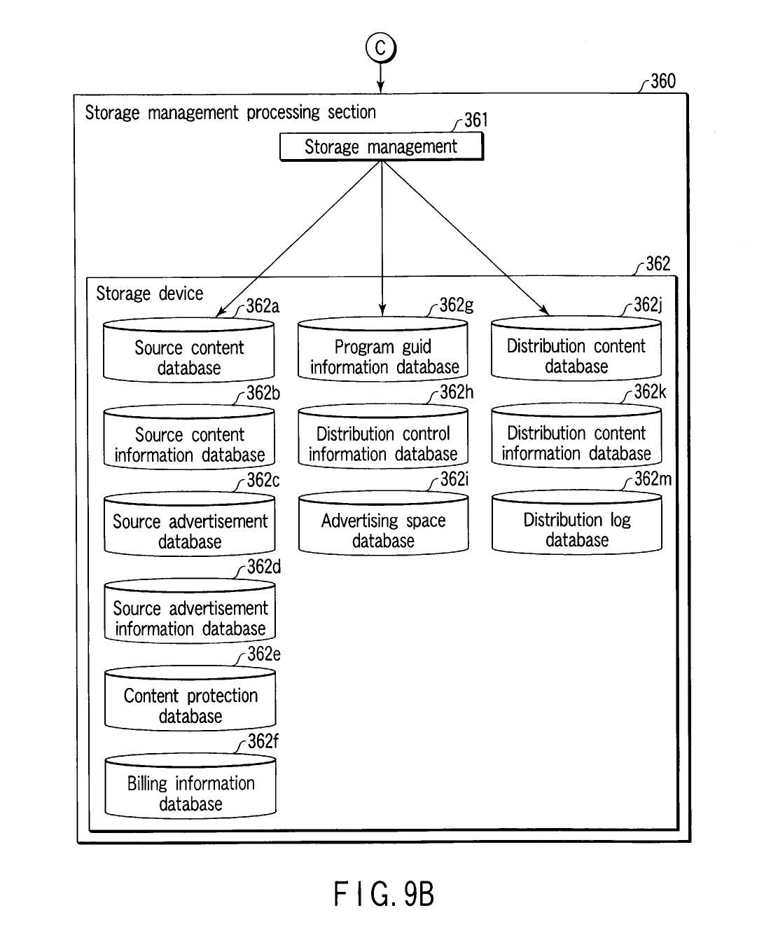

FIGS. 9A and 9B are block diagrams showing an embodiment of the content distribution apparatus 300.

The content distribution apparatus 300 comprises a content processing section 310, advertisement processing section 320, content-advertisement processing section 330, content selection promoting section 340, content-advertisement distribution section 350, and storage management processing section 360.

The content processing section 310 comprises a content information input means 311, content input means 312, content protection/registration means 313, watching information input means 314, billing information input means 315, and billing information distribution means 316.

The content information input means 311 has a function of, upon receiving a content purchase end notification from the content buying apparatus 200, receiving the content information of the purchased contents from the content buying apparatus 200. The contents here mean contents that the content buying apparatus 200 receives from the content evaluation apparatus 100 on the basis of a content evaluation/analysis request and an excellent content that the content buying apparatus 200 directly receives from the content evaluation apparatus 100.

After the content information input means 311 receives the content information, the content input means 312 receives contents from the content buying apparatus 200 on the basis of content position information contained in the content information. The content protection/registration means 313 executes protection processing such as encryption or watermark for the content information and contents received from the content buying apparatus 200, stores them in a storage device 362, and sends a notification to the content-advertisement processing section 330. The watching information input means 314 requests the content evaluation apparatus 100, receives watching statistical information related to content and advertisement watching, extracts content watching information from the information, and transmits the content watching information to the content-advertisement processing section 330.

The billing information input means 315 has a function of requesting the content evaluation apparatus 100, receiving billing information related to content and advertisement watching, executing statistical processing for, e.g., each time or season, and causing the billing information distribution means 316 to distribute the statistical processing result to the content buying apparatus 200 and advertisement acquisition processing apparatus 400.

The advertisement processing section 320 comprises an advertisement information input means 321, advertisement input means 322, advertisement protection/registration means 323, and advertising space information output means 324.

The advertisement information input means 321 receives a notification of advertising space purchase processing for contents from the advertisement acquisition processing apparatus 400 and receives advertising content information containing advertising space information from the advertisement acquisition processing apparatus 400. The advertisement input means 322 has a function of receiving advertisements from the advertisement acquisition processing apparatus 400 on the basis of advertisement position information contained in the received advertising content information.

The advertisement protection/registration means 323 executes protection such as watermark for the advertising contents, stores them in the storage device 362, and notifies the content-advertisement processing section 330 of the end of advertisement input processing.

The content-advertisement processing section 330 has a program schedule data generation means 331, advertising space management means 332, advertising space information input/output means 333, and distribution control information generation/registration means 334.

The content-advertisement processing section 330 also has a program guide control data generation/registration means 335, program guide control data transmission means 336, program selection information reception means 337, and distribution control information search/output means 338.

Upon receiving content information containing contents from the advertisement processing section 320, the program schedule data generation means 331 analyzes the content information. The program schedule data generation means 331. generates temporary program schedule data by deciding the order of distribution of advertising space information, contents, and advertisements, distribution time, and the display positions of the contents and advertisements in the monitor connected to the viewer apparatus 2 while considering the advertising space information of the contents. The program schedule data generation means 331 provides the advertising space information to the advertisement providing apparatus 5 through the advertising space management means 332, advertising space information input/output means 333, and advertisement acquisition processing apparatus 400, thereby selling advertising spaces. In addition, upon receiving an advertising space purchase contract from the advertisement providing apparatus 5 and then advertising content information, the program schedule data generation means 331 makes a program schedule in which advertising contents are inserted using advertising spaces, generates program distribution control data, and distributes the programs.

If an unsold advertising space still remains in a content, the program schedule data generation means 331 selects an appropriate advertisement for the content in consideration of the personal taste information and regional taste information and inserts the selected advertisement to the unsold advertising space. In this way, the program schedule data generation means 331 makes a program with appropriate advertisements inserted to all advertising spaces.

The distribution control information generation/registration means 334 generates program distribution control information on the basis of the program schedule data created by the program schedule data generation means 331 and stores and manages the program distribution control information together with the advertising space information in a distribution control information database 362h and advertising space database 362i of the storage device 362 using a storage management means 361.

The program guide control data generation/registration means 335 receives the program schedule data generated by the program schedule data generation means 331, generates control data necessary for program guide, stores it in a program guide information database 362g of the storage device 362 using the storage management means 361, and sends the program schedule data to the content selection promoting section 340 through the program guide control data transmission means 336. The content selection promoting section 340 provides the program guide data to the viewer apparatus 2.

After providing the program guide data to the viewer apparatus 2, the program selection information reception means 337 receives the content selection information of a program selected by the viewer, which is sent from the content selection promoting section 340 side, and sends the content selection information to the distribution control information search/output means 338. Upon receiving push distribution data as the content selection information of the program from the program selection information reception means 337, the distribution control information search/output means 338 searches the distribution control information database 362h of the storage device 362 for corresponding distribution control information using the storage management means 361 and sends the distribution control information to the content-advertisement distribution section 350. For pull distribution, the distribution control information search/output means 338 searches, using the storage management means 361, the distribution control information database 362h of the storage device 362 for distribution control information for distributing corresponding contents and accompanying advertisements independently of time and sends the distribution control information to the content-advertisement distribution section 350.

The content selection promoting section 340 is constituted by a program guide data processing means 341 and program selection data processing means 342.

The program guide data processing means 341 generates program guide data on the basis of the content program guide control information transmitted from the program guide control data transmission means 336, stores the program guide data in the program guide information database 362g through the storage management means 361, and transmits the program guide data to the viewer apparatus 2 to promote content purchase by the viewer. The program guide control information contains information necessary for the guide, i.e., a distribution control information pointer, title arrangement, advertisement arrangement, and price. The program guide data is expressed as a guide of program (e.g., push distribution) or content (e.g., pull distribution).

The viewer apparatus 2 displays the program guide data and sends content selection information as program selection data designated by the viewer to the program selection data processing means 342.

The program selection data processing means 342 receives the content selection information, determines whether the program is a pull type or push type, and sends the content selection information to the program selection information reception means 337.

The content-advertisement distribution section 350 has a distribution control means 351, content advertisement input means 352, conventionally known conversion/compression means 353, encryption means 354, and distribution means 355.

Upon receiving the distribution control information from the content-advertisement processing section 330 (S381), the distribution control means 351 of the content-advertisement distribution section 350 finally executes content or advertisement distribution control in accordance with the distribution control information. More specifically, the distribution control means 351 checks the distribution type from the distribution control information and executes the following distribution control.

a) The distribution control means 351 transmits the distribution control information to the viewer apparatus 2 (S382) and acquires content or advertisement request information from the viewer apparatus 2. In accordance with the request information from the viewer apparatus 2, the distribution control means 351 searches the storage device 362 for the content or advertisement and transmits it to the viewer apparatus 2.

b) When advertisements should be inserted to the content in accordance with the distribution control information, the distribution control means 351 transmits the content to the viewer apparatus 2 while inserting advertisements to the content. The viewer apparatus 2 selects a program by a so-called channel scheme.

c) When a program schedule is reflected on the distribution control information, the distribution control means 351 transmits one content corresponding to the distribution time to the viewer apparatus 2 in a form of, e.g., a content element, advertisement, content element, advertisement, . . . in accordance with the distribution control information. By repeating this processing a plurality of number of times, the distribution control means 351 executes distribution control corresponding to the program schedule of a day.

The content-advertisement distribution section 350 executes distribution control on the basis of the distribution control information and executes reception of contents and advertisements, conversion and compression of sequential format, encryption, and distribution of programs with advertisements and contents inserted.

Processing by the content distribution apparatus 300 will be described next with reference to the accompanying drawing.

1) Processing by the Content Processing Section 310 is Divided into Content Information/Content Acquisition Processing, Watching Information Acquisition Processing, and Billing Information Acquisition Processing.

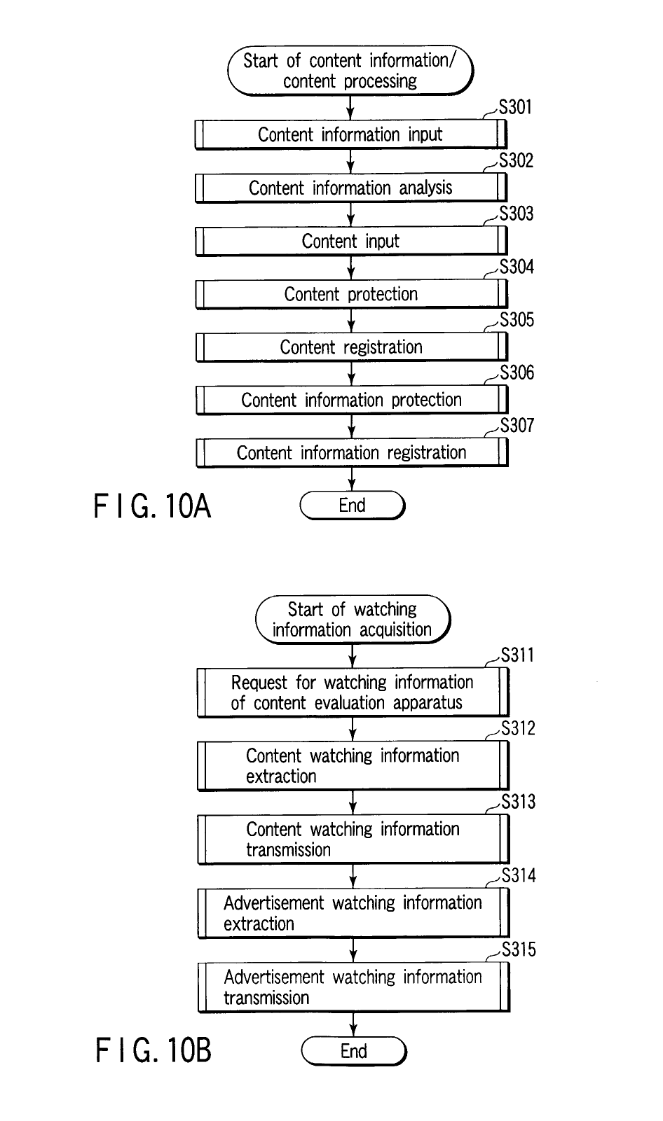

a) Content/Content Information Acquisition Processing (FIG. 10A)

Upon receiving, e.g., an excellent content purchase end notification from the content buying apparatus 200, the content processing section 310 receives the content information of the purchased excellent contents from the content buying apparatus 200 (S301: content information input means), extracts advertisement insertion enable information and content position information contained in the content information, and analyzes the position information, thereby acquires the contents from the content buying apparatus 200. Steps S302 and S303 are executed by the content input means 312.

After that, the content protection/registration means 313 executes protection such as watermark for the received contents (S304) and stores them in a source content database 362a in the storage device 362 using the storage management means 361 (S305). The content protection/registration means 313 also executes protection such as encryption for the content information (S306) and stores them in a source content information database 362b in the storage device 362 using the storage management means 361 (S307). The content protection/registration means 313 stores the contents and then notifies the content-advertisement processing section 330 of the storage state of the contents.

b) Watching Statistical Information Acquisition Processing (FIG. 10B)

The watching information input means 314 requests statistical information about content and advertisement watching of the content evaluation apparatus 100 (S311) and extracts content watching information from the statistical information about content watching (S312). The extracted content watching information is transmitted to the content-advertisement processing section 330 (S313). Similarly, the watching information input means 314 extracts advertisement watching information from the statistical information about advertisement watching (S314) and transmits the extracted advertisement watching information to the content-advertisement processing section 330 (S315).

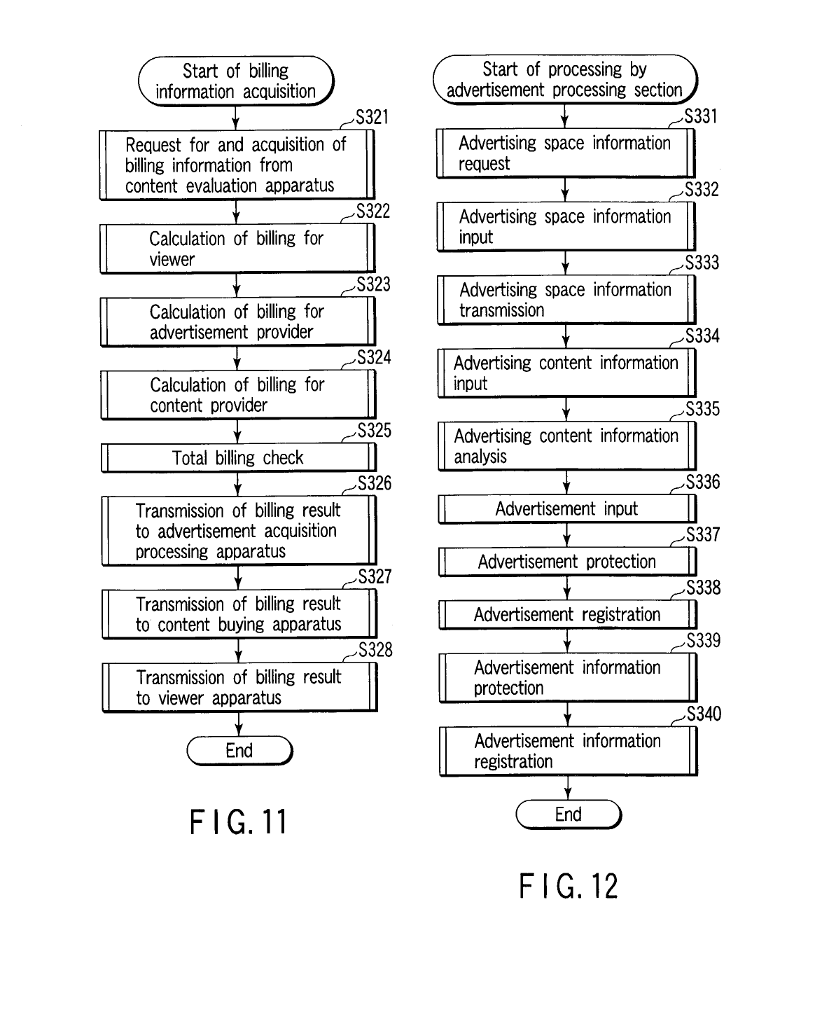

c) Billing Information Acquisition Processing (FIG. 11)

On the other hand, the billing information input means 315 requests billing information for watching of the content evaluation apparatus 100 and acquires billing information from the content evaluation apparatus 100 (S321).

Subsequently, the billing information input means 315 executes billing calculation for the viewer (S322), billing calculation for the advertisement provider (S323), and billing calculation for the content provider (S324) on the basis of the billing information. Then, the billing information input means 315 totally checks whether the calculated billing results have no inconsistency (S325). If the billing information distribution means 316 determines that there is no inconsistency, it distributes the billing results to the advertisement providing apparatus 5, content buying apparatus 200, and viewer apparatus 2 (S326 through S328).

2) Processing by Advertisement Processing Section 320 (FIG. 12)

The advertising space information output means 324 of the advertisement processing section 320 requests current advertising space information of the content-advertisement processing section 330 (S331). Upon receiving the advertising space information from the content-advertisement processing section 330 (S332), the advertising space information output means 324 transmits it to the advertisement providing apparatus 5 through the advertisement acquisition processing apparatus 400 (S333). After that, upon receiving an advertising space purchase processing notification for advertising contents from the advertisement acquisition processing apparatus 400, the advertisement information input means 321 receives advertising content information containing the purchased advertising space information from the advertisement acquisition processing apparatus 400 (S334), analyzes the advertising content information to extract the advertisement position information contained in the advertising content information, and sends the position information to the advertisement input means 322. The advertisement input means 322 receives advertising contents from the advertisement providing apparatus 5 through the advertisement acquisition processing apparatus 400 on the basis of the advertisement position information (S335 and S336).

The advertisement protection/registration means 323 executes protection such as watermark for the advertising contents received in step S336 (S337) and stores them in a source advertisement database 362c of the storage device 362 (S338). The advertisement protection/registration means 323 also executes protection such as encryption for the advertising content information (S339), stores them in a source advertisement information database 362d of the storage device 362 (S340), and notifies the content-advertisement processing section 330 of the end of advertisement input processing.

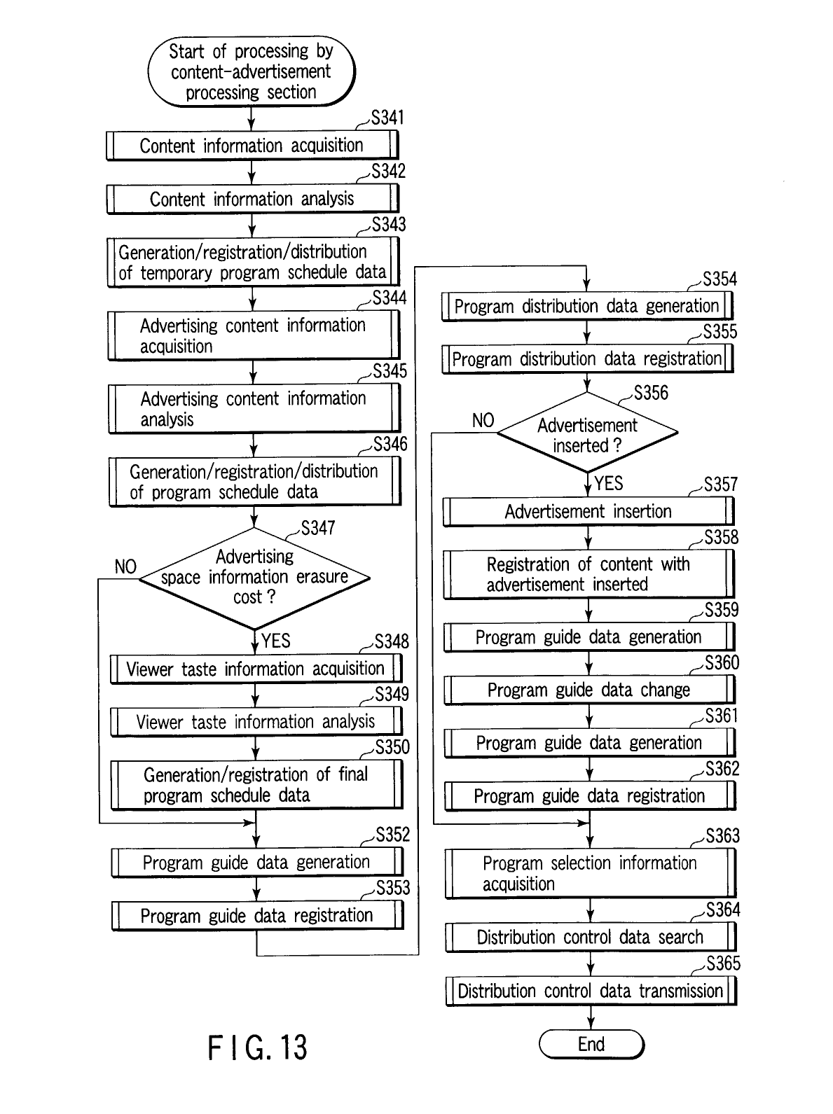

3) Processing by Content-Advertisement Processing Section 330 (FIG. 13)

Upon receiving a content input processing end notification from the advertisement processing section 320, the program schedule data generation means 331 of the content-advertisement processing section 330 receives the contents and content information from the databases 362a and 362b of the storage device 362 (S341). The program schedule data generation means 331 analyzes the content information (S342) to generate temporary program schedule in consideration of the advertising spaces for the contents of the content provider by deciding the distribution order of the contents and advertisements, distribution time, and the display positions of the contents and advertisements in the monitor connected to the viewer apparatus 2. The program schedule data generation means 331 generates advertising space information on which the temporary programs are reflected, stores it in the advertising space database 362i of the storage device 362, and notifies the advertisement processing section 320 and advertisement providing apparatus 5 of the advertising space information through the advertising space management means 332 and advertising space information input/output means 333 (S343).

Upon receiving an advertising space purchase notification from the advertisement providing apparatus 5, the program schedule data generation means 331 receives advertising content information (advertising content information, advertising space purchase information, advertisement position information, and the like) corresponding to the advertising content from the source advertisement information database 362d (S344) and analyzes the advertising content information (S345). On the basis of the advertising space purchase information for the contents, the program schedule data generation means 331 refers to the temporary programs and sequentially repeats advertising space processing for each advertising space buyer for the contents, thereby generating program schedule data (S346).

If an unsold advertising space still remains in a content, the program schedule data generation means 331 receives personal taste information and regional taste information, which are watching information based on the past log, from a database 362m and the like (S348), analyzes the taste information of the viewer (S349), selects an appropriate advertisement for the content, and inserts the advertisement to the unsold advertising space. In this way, the program schedule data generation means 331 makes final program schedule data with appropriate advertisements inserted to all the advertising spaces of the content and registers the program schedule data in a program guide information database 362g of the storage device 362.

After that, the program guide control data generation/registration means 335 receives the program schedule generated by the program schedule data generation means 331 and filters only data necessary for the program guide to generate program guide control data (S352). The program guide control data generation/registration means 335 stores the program guide control data in the program guide information database 362g of the storage device 362 (S353) and transmits the program guide control data to the viewer apparatus 2 through the program guide control data transmission means 336.

On the other hand, the distribution control information generation/registration means 334 generates program distribution data from the final program schedule data (S354) and stores the generated program distribution data in the distribution control information database 362h of the storage device 362 (S355). The distribution control information generation/registration means 334 also stores the advertising space information finally decided in the advertising space database 362i of the storage device 362. The advertising space information contains information necessary for advertising space management and, for example, information representing the unit time length in seconds and position of an advertisement in a content that can have advertisements, and the possible number of times of insertion of that advertisement. Hence, advertising spaces usable in a content, and each advertising space and a content or advertisement that uses that advertising space can be managed.

The distribution control information generation/registration means 334 also determines the presence/absence of advertisement insertion for the program distribution data stored in the distribution log database 362m (S356). If it is determined that advertisements can be inserted, advertising contents are inserted into the content (S357) and registers them in, e.g., an object content database 362j (S358). If it is determined that no advertisements can be inserted, the series of processes are omitted.

The distribution control information generation/registration means 334 reads out the program guide data already registered in the program guide information database 362g, generates program guide data with advertisements inserted on the basis of the program guide data (S359), and updates the program guide data already registered in the program guide information database 362g (S360).

After the program guide control data transmission means 336 transmits the program guide data to the viewer apparatus 2, the program selection information reception means 337 acquires program selection information (content selection information) selected by the viewer through the content selection promoting section 340 (S363) and sends it to the distribution control information search/output means 338. The received program selection information contains distribution control information such as the content pointers and advertisement pointers. Hence, the distribution control information search/output means 338 searches the distribution control information database 362h of the storage device 362 for distribution control information on the basis of the distribution control information (S364) and sends the found distribution control information to the content-advertisement distribution section 350 (S356).

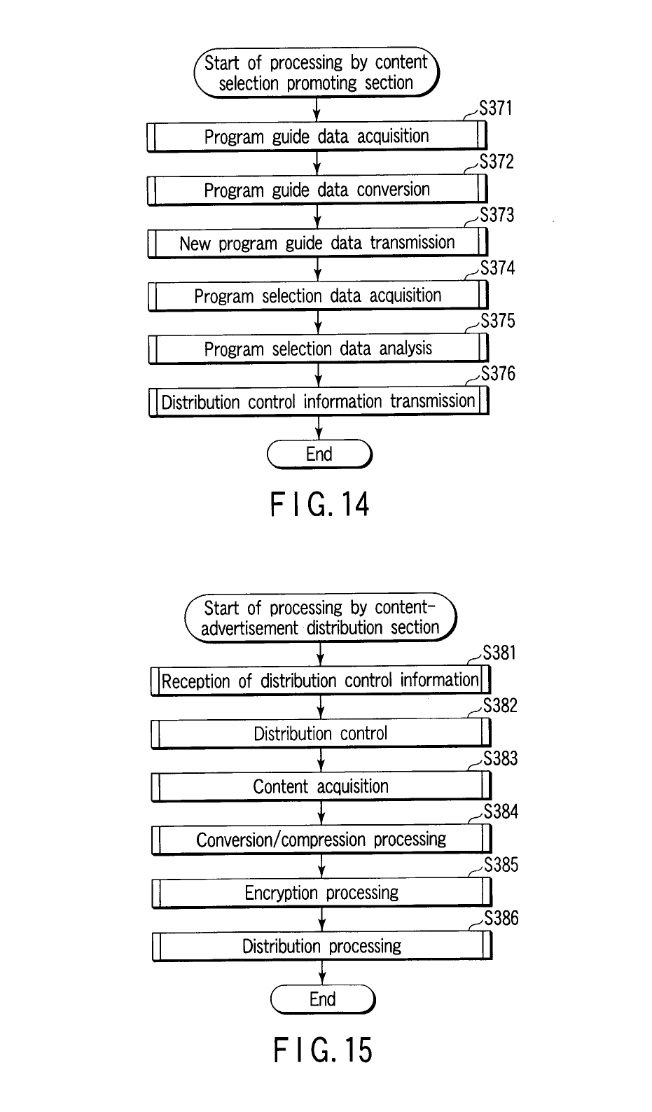

4) Processing by Content Selection Promoting Section 340 (FIG. 14)

Upon receiving the content program guide control data from the content-advertisement processing section 330 (S371), the program guide data processing means 341 converts the data into program guide data for content promotion by the viewer (S372), stores the program guide data in the program guide information database 362g of the storage device 362, and transmits the program guide data to the viewer apparatus 2 as new program guide data (S373). The program guide control data contains information necessary for the guide, i.e., a distribution control information pointer, title arrangement, advertisement arrangement, and price.

The viewer apparatus 2 displays the program guide in accordance with the new program guide data and transmits the content selection information designated by the viewer to the program selection data processing means 342. The program selection data processing means 342 receives the program selection information (S374), determines the distribution type (S375), and transmits the distribution type to the content-advertisement processing section 330.

The program selection information reception means 337 of the content-advertisement processing section 330 receives the distribution type information and sends it to the distribution control information search/output means 338.

If the distribution type is a push type, the distribution control information search/output means 338 searches the distribution control information database 362h of the storage device 362 for corresponding distribution control information and transmits the distribution control information to the content-advertisement distribution section 350 (S376).

Upon receiving the distribution control information from the content-advertisement processing section 330, the content-advertisement distribution section 350 searches the source content database 362a or source advertisement database 362c of the storage device 362 for the content or advertisement that should currently be distributed and transmits the content or advertisement to the viewer apparatus 2. If the distribution type is a pull type, the distribution control information search/output means 338 searches the distribution control information database 362h of the storage device 362 for control information for distributing corresponding contents and accompanying advertisements independently of time and transmits the distribution control information to the content-advertisement distribution section 350 (S376).

5) Processing by Content-Advertisement Distribution Section 350 (FIG. 15)

Upon receiving the distribution control information from the content-advertisement processing section 330 (S381), the content-advertisement distribution section 350 finally executes content or advertisement distribution control in accordance with the distribution control information. More specifically, the content-advertisement distribution section 350 checks the distribution type from the distribution control information and executes the following distribution control.

a) The distribution control means 351 transmits the distribution control information to the viewer apparatus 2 (S382) and acquires content or advertisement request information from the viewer apparatus 2. The distribution control means 351 searches the storage device 362 for the content or advertisement in accordance with the request information from the viewer apparatus 2 and transmits the content or advertisement to the viewer apparatus 2.

b) When advertisements are to be inserted to the content in accordance with the distribution control information, the distribution control means 351 transmits the content to the viewer apparatus 2 while inserting advertisements to the content. The viewer apparatus 2 selects a program by a so-called channel scheme.

c) When a program schedule is reflected on the distribution control information, the distribution control means 351 transmits one content corresponding to the distribution time to the viewer apparatus 2 in a form of, e.g., a content element, advertisement, content element, advertisement, . . . in accordance with the distribution control information. By repeating this processing a plurality of number of times, the distribution control means 351 executes distribution control corresponding to the program schedule of a day.

While executing distribution control (S382), the content-advertisement distribution section 350 executes reception of contents and advertisements (S383), conversion and compression of sequential format (S384), encryption (S385), and distribution (S386). Reception of contents and advertisements, conversion and compression of sequential format, encryption, and distribution to be described below may be executed for contents in which advertisements are inserted in advance. The content-advertisement distribution section 350 stores the log of distribution processing in the distribution log database 362m.

According to the embodiment of the content distribution apparatus 300 having the above arrangement, advertising space information and temporary programs are scheduled on the basis of the content information of contents bought by the content buying apparatus 200. The advertising space information is transmitted to the advertisement providing apparatus 5 to sell advertising spaces of programs. When the advertisement provider makes a contract to purchase advertising spaces to which advertisements are to be inserted, advertising contents and advertising content information are acquired from the advertisement providing apparatus 5 in accordance with the purchase contract, actual programs are scheduled, and distribution control information and program guide control data are generated on the basis of the program schedule. Program guide data generated from the program guide control data is provided to the viewer apparatus 2, and distribution control is executed on the basis of the distribution type based on program selection information acquired from the viewer apparatus 2. This prompts the advertisement provider to supply advertising contents, so excellent contents and advertisements can be appropriately provided to the viewer.

### VII. Advertisement Acquisition Processing Apparatus 400

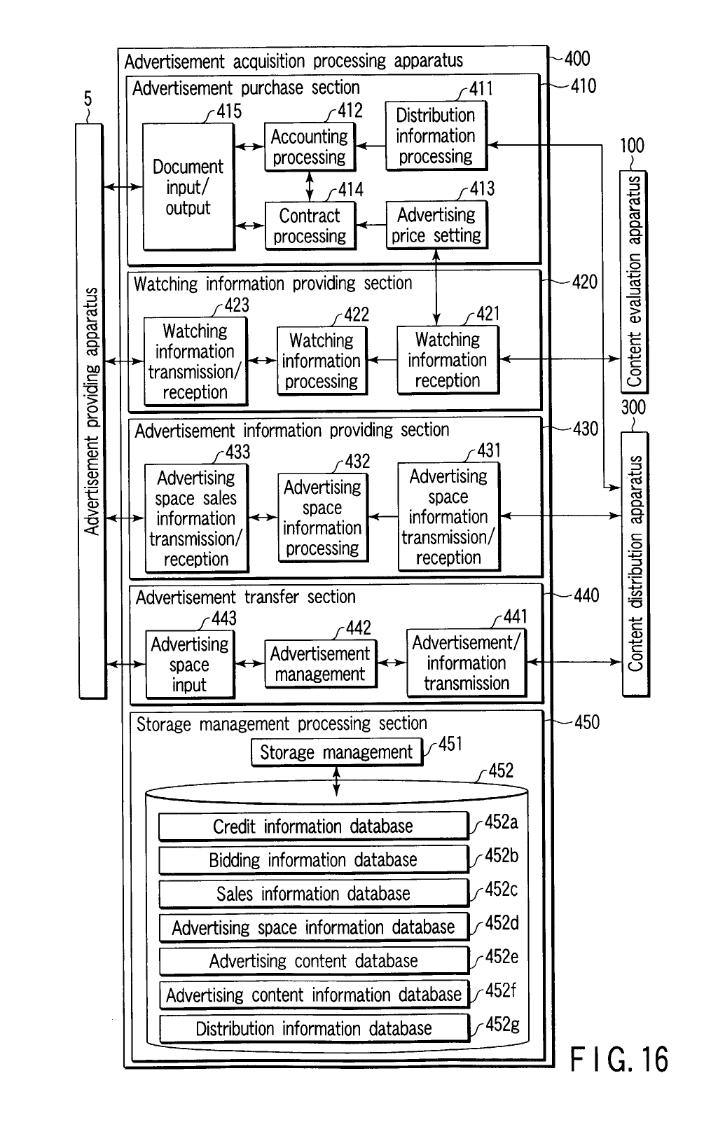

FIG. 16 is a block diagram showing an embodiment of the advertisement acquisition processing apparatus 400.

The advertisement acquisition processing apparatus 400 displays, for the advertisement provider, the past watching information (content title, age, and sex) of advertising spaces to be sold before sales of the advertising spaces and prompts the advertisement provide to purchase the advertising spaces. The advertisement acquisition processing apparatus 400 also electronically acquires advertising spaces to be added to contents from the advertisement providing apparatus 5 as an advertisement provider. When the advertisement provider decides to purchase advertising spaces, an advertising fee calculated by the calculation method (to be described later) is paid to the advertisement acquisition processing apparatus 400 side.

Examples of advertisements acquired by the advertisement acquisition processing apparatus 400 are as follows.

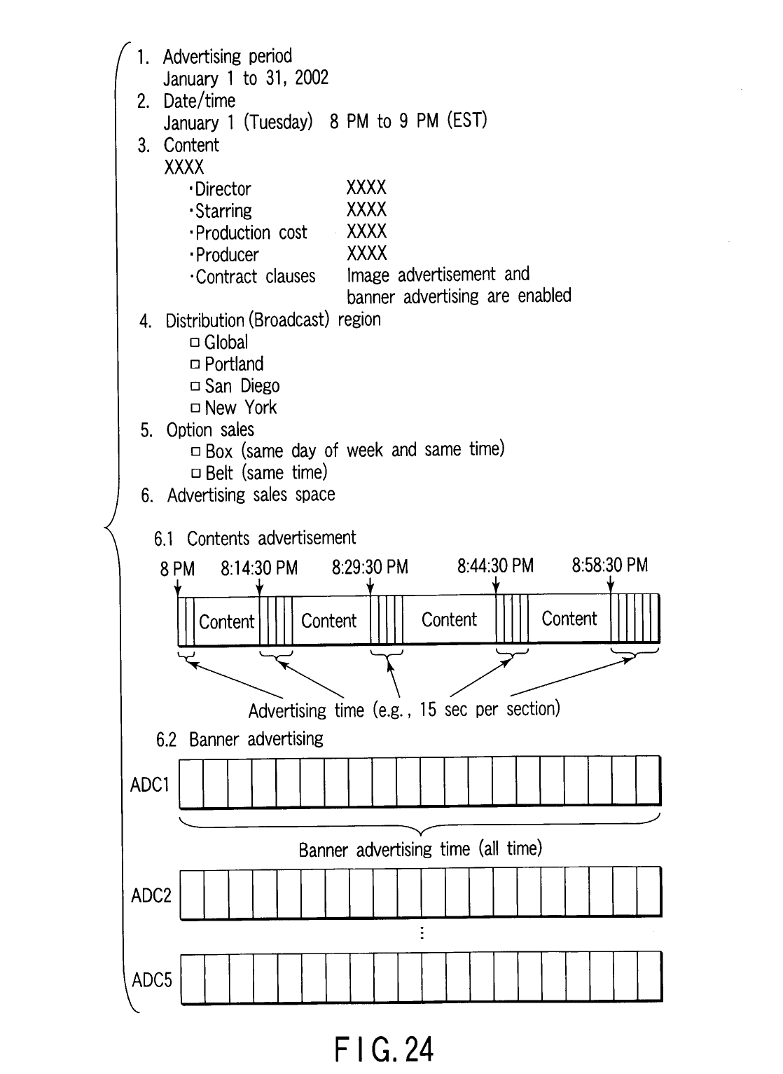

Banner advertising spatially using the monitor screen (FIG. 24)

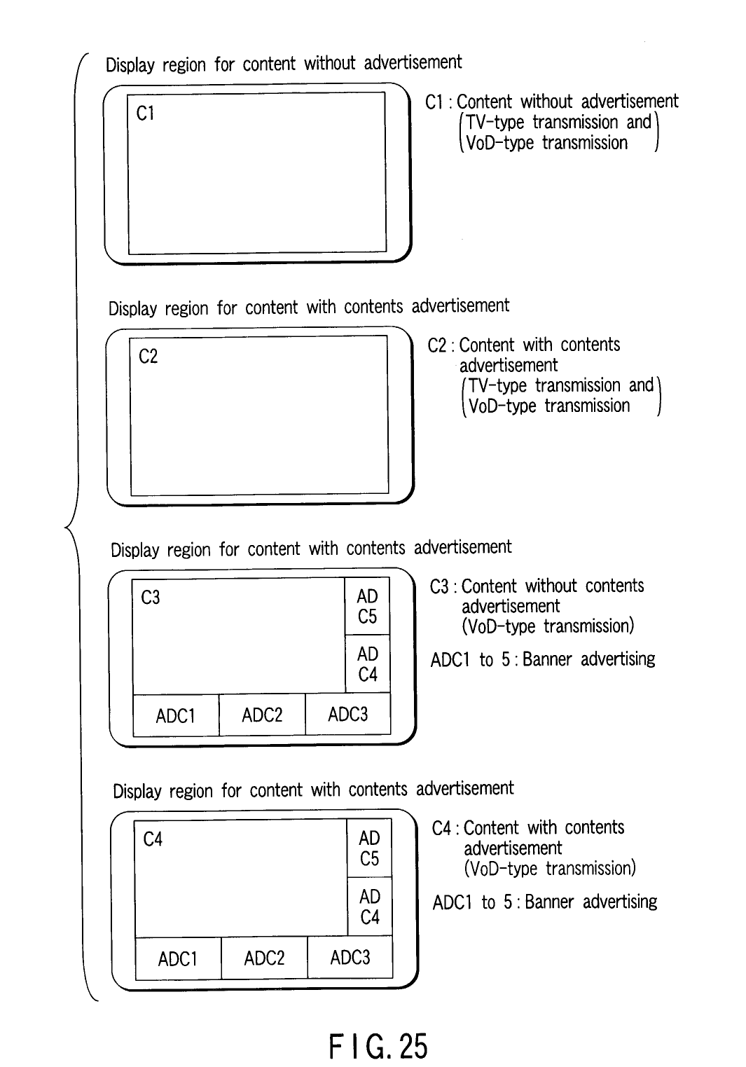

Contents advertisement: advertisements are inserted to form one content (FIG. 25)

More specifically, the advertisement acquisition processing apparatus 400 presents, to the advertisement providing apparatus 5 as an advertisement provider, advertising space information corresponding to a program schedule made by the program schedule data generation means 331 of the content-advertisement processing section 330 in the content distribution apparatus 300. The advertisement provider of the advertisement providing apparatus 5 refers to the advertising space information and acquires purchase decision information of advertising spaces to which advertisements are to be inserted.

Examples of advertising space information are as follows.

Distribution date/time

Channel information (including distribution by VOD)

Region information

Content information

Price

In the above-described example, advertisements are acquired on the basis of agreement with the advertisement provider for the scheduled advertisement distribution time. Alternatively, advertisements may be acquired on the assumption that no scheduled distribution time is designated, and advertisements should be dynamically inserted (to be referred to as dynamic inserted advertisement hereinafter). Examples of dynamic inserted advertisements are as follows.

Advertisements inserted when the viewer temporarily stops watching due to some reason

Advertisements inserted to fill the change processing time when the viewer changes the function, e.g., channel.

Advertisements inserted to fill the content download time in a VOD service

Advertisements inserted to advertising spaces that are presented but unsold

For the dynamic inserted advertisements, advertisement conditions and advertising fee are presented to the advertisement provider. The dynamic inserted advertisements do not guarantee program distribution by advertisements, through the advertising contents are distributed in accordance with the customer target of the advertisement provider on the basis of advertising content information added to the advertising contents. As the advertising cost, a registration basic fee and an advertising fee for use of advertising spaces are collected from the advertisement provider on the basis of the distribution information (number of times of distribution) transmitted from the content distribution apparatus 300.

The advertisement acquisition processing apparatus 400 will be described below in detail.

The advertisement acquisition processing apparatus 400 is constituted by an advertisement purchase section 410, watching information providing section 420, advertisement information providing section 430, advertisement transfer section 440, and storage management processing section 450 having a storage management means 451 and storage device 452.

The advertisement purchase section 410 has a function of confirming the credit information of the advertisement provider, updating a credit information database 452a of the storage device 452, managing bidding information and advertising space sales information, updating a bidding information database 452b and sales information database 452c of the storage device 452, and collecting the advertising fee.

The advertisement purchase section 410 has a distribution information processing means 411, accounting processing means 412, advertising price setting means 413, contract processing means 414, and document input/output means 415.

The distribution information processing means 411 receives distribution information such as the number of times of distribution from the content distribution apparatus 300 and stores the distribution information in a distribution information database 452g. The distribution information processing means 411 also requests the accounting processing means 412 to collect when advertising spaces are sold and collect additional advertising fee.

The accounting processing means 412 collects the advertising fee when advertising spaces are sold. When advertisements are dynamically distributed on the basis of advertisement distribution information, the accounting processing means 412 executes additional advertising fee collection in accordance with the number of times of distribution.

The advertising price setting means 413 has a function of receiving watching information from the watching information providing section 420 and calculating the advertising fee on the basis of the past watching information (audience rating) for each advertising space.

The contract processing means 414 has a function of confirming the credit information of the advertisement provider, updating the credit information database 452a of the storage device 452, managing the bidding information and advertising space sales information, updating the bidding information database 452b and sales information database 452c, and sending the advertising fee calculated by the advertising price setting means 413 to the accounting processing means 412.

The document input/output means 415 has a format conversion function and communication function necessary for electronic business information interchange (EDI). The document input/output means 415 exchanges business information such as advertising fee collection data, additional advertising fee collection data, and advertising space sales information between the advertisement providing apparatus 5 connected to the network apparatus 1 and the terminal 6 held by a credit service agency or accounting settlement service agency.

The watching information providing section 420 acquire watching information for each advertising space from the content evaluation apparatus 100 and presents the watching information to the advertisement providing apparatus 5. The watching information providing section 420 comprises a watching information reception means 421, watching information processing means 422, and watching information transmission/reception means 423.

The watching information reception means 421 receives watching information from the content evaluation apparatus 100 and sends the watching information to the watching information processing means 422 and advertising price setting means 413. The watching information processing means 422 has a function of receiving the watching information from the watching information reception means 421, generating a watching information search window for each advertising space, inquiring of the content evaluation apparatus 100 about a database through CGI (Common Gateway Interface) in accordance with a search key input by the advertisement providing apparatus 5, and displaying the inquiry result. The watching information transmission/reception means 423 has a function of transmitting/receiving the window information generated by the watching information processing means 422 using HTTP or the like.

The advertisement information providing section 430 acquires advertising space information from the content distribution apparatus 300, stores the acquired advertising space information in an advertising space information database 452d of the storage device 452, and discloses advertising space sales information containing the advertising space information to the advertisement providing apparatus 5. The advertisement information providing section 430 comprises an advertising space information transmission/reception means 431, advertising space information processing means 432, and advertising space sales information transmission/reception means 433.

The advertising space information transmission/reception means 431 receives the advertising space information transmitted from the content evaluation apparatus 100 and sends the advertising space information to the advertising space information processing means 432. The advertising space information processing means 432 has a function of receiving the advertising space information from the advertising space information transmission/reception means 431, storing the distribution in the advertising space information database 452d of the storage device 452, and generating an advertising space sales window. The advertising space sales information transmission/reception means 433 inputs/outputs the advertising space sales window generated by the advertising space information processing means 432.

The advertisement transfer section 440 acquires advertising contents and advertising content information, stores them in an advertising content database 452e and advertising content information database 452f, and transmits them to the content distribution apparatus 300. The advertisement transfer section 440 is constituted by an advertisement input means 441, advertisement management means 442, and advertisement/information transmission means 443.

The advertisement input means 441 receives advertising contents and advertising content information from the advertisement providing apparatus 5. The advertisement management means 442 stores the received advertising contents and advertising content information in the advertising content database 452e and advertising content information database 452f. The advertisement/information transmission means 443 has a function of transmitting the advertising contents and advertising content information to the content distribution apparatus 300.

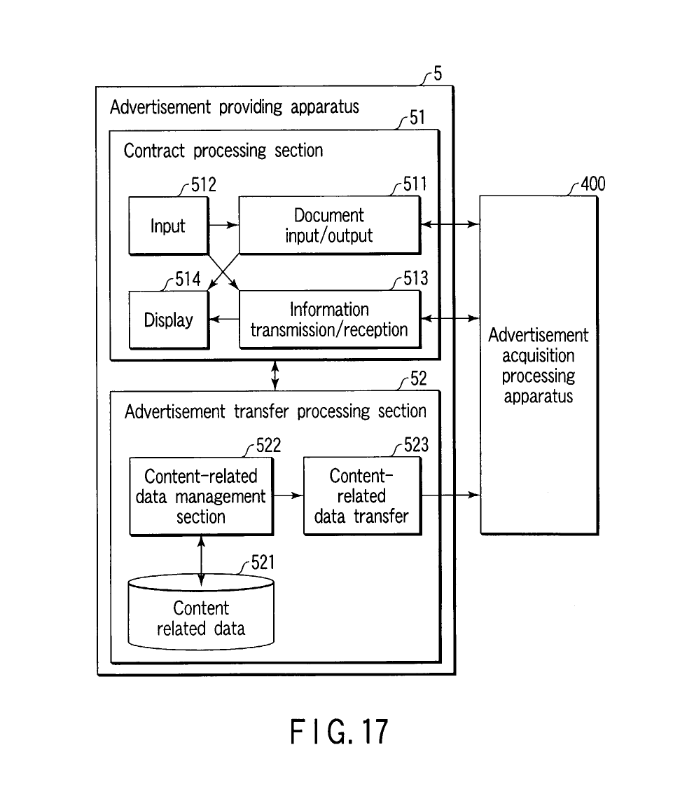

Before a description of a series of processes of the advertisement acquisition processing apparatus 400, the schematic arrangement of the advertisement providing apparatus 5 will be described with reference to FIG. 17.

The advertisement providing apparatus 5 has at least a contract processing section 51 which processes a contract containing an amount, watching information, and advertising space information transmitted from the advertisement acquisition processing apparatus 400, and an advertisement transfer section 52 which transfers content-related data such as advertising contents and advertising content information on the basis of the contract by the contract processing section 51.

The contract processing section 51 is constituted by a document input/output means 511 for transmitting/receiving document data related to a contract containing an amount, an input means 512 for inputting necessary data in accordance with a contract and the like as needed, an information transmission/reception means 513 for transmitting/receiving watching information, advertising space information, and the like, and a display means 514 for displaying information necessary for the document input/output means 511 and information transmission/reception means 513.

The advertisement transfer section 52 has at least a database 521 which stores advertising content, advertising content information, and related data, a management means 522 for managing storage in the database 521, reading out necessary data from the database 521 in cooperation with the contract processing section 51, and storing additional advertising contents and advertising content information, and an advertising-content-related data transfer means 523 for transferring advertising contents and advertising content information.

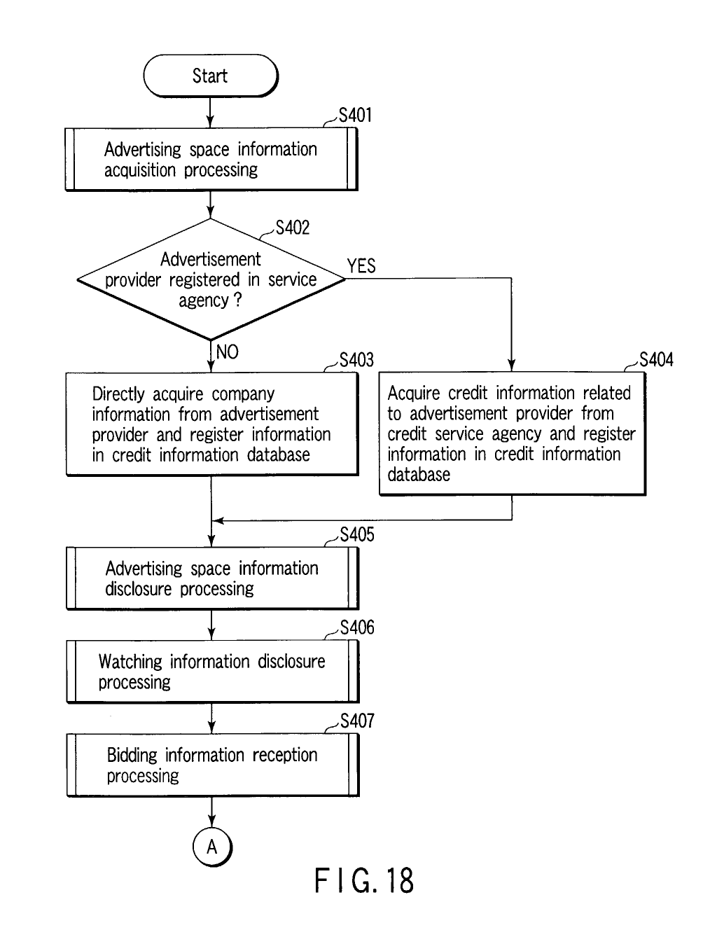

The advertisement acquisition processing apparatus 400 will be described next with reference to the accompanying drawing (FIGS. 18 and 19).

1) Advertising Space Information Acquisition Processing (S401)

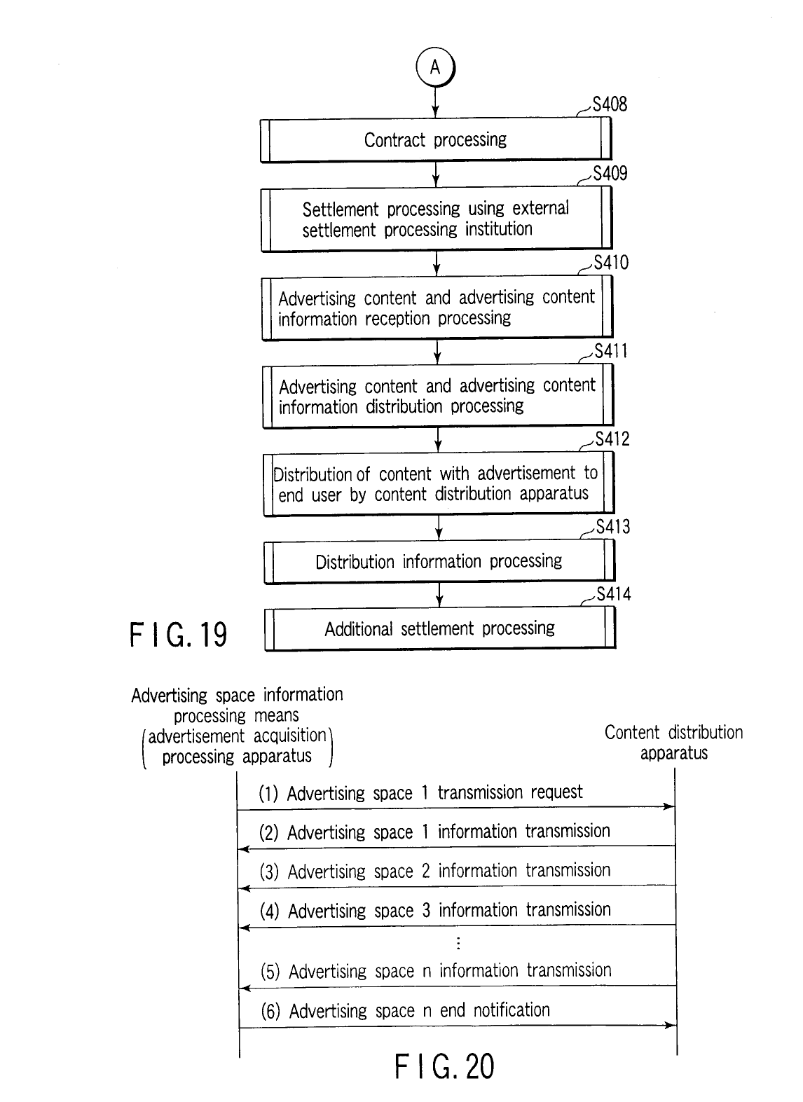

\mathring{1} The advertising space information transmission/reception means 431 of the advertisement acquisition processing apparatus 400 executes advertising space information transmission/reception processing as shown in FIG. 20 with respect to the content distribution apparatus 300. More specifically, the advertising space information transmission/reception means 431 transmits an advertising space information transmission request to the distribution apparatus 300 together with an advertising space number (serial number). The advertising space number is a unique number between the advertisement acquisition processing apparatus 400 and the content distribution apparatus 300.

\mathring{2} Upon receiving the advertising space information transmission request, the content distribution apparatus 300 transmits information related to advertising space 1 designated by the transmission request. The advertising space information is received by the advertising space information transmission/reception means 431 and sent to the advertising space information processing means 432. The advertising space information processing means 432 stores the received advertising space information in the advertising space information database 452d of the storage device 452.

The advertising space information database 452d stores, e.g., an advertising space number, advertisement insertion date, advertisement insertion day of the week, advertisement insertion time, advertisement end time, distribution region, advertising space type (SP, CC, or HHSB: FIG. 25), advertisement (C, ADC1 through ADC5), channel information (for a VOD content, a special channel name), content information (content title, content genre, actors, director, sales information, and running time), and next advertising space number. CC indicates a cowcatcher (an advertisement distribution before a content); SP, a spot (an advertisement distribution during a content); HH, a hitchhike (an advertisement distribution after end of a content); and SB, a station break (an advertisement distribution outside and between contents). When the advertising space type is SP, two pieces of content information are necessary for inserting an advertisement between two contents. C indicates a contents advertisement. ADC1 through ADC5 correspond to a banner area divided into five parts, as shown in FIG. 24.

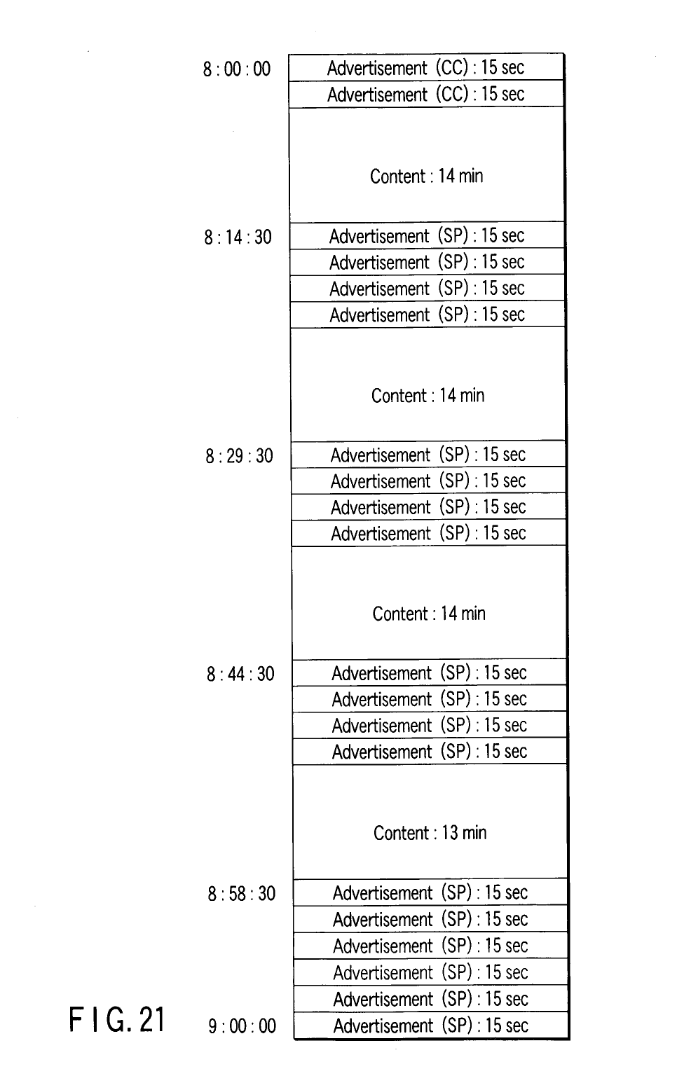

FIG. 21 is a view showing a simple advertisement insertion point model. To designate the first advertising space, advertising space information contains the following information.

Advertising space number: 1

Advertisement insertion date: Jan. 1, 2001

Advertisement insertion day of the week: Tuesday

Advertisement insertion time: 8:00:00

Advertisement end time: 8:00:15

Distribution region: San Diego

Advertising space type: CC

Advertisement type: C (contents advertisement)

Channel information: ABC (example)

Content information: Titanic (example)

Next advertising space number: 2

If both a contents advertisement and banner advertising are permitted at the same time, information is transmitted for another advertising space number (FIG. 24). For example, information of an advertising space distributed in the ADC1 area from 8:00:00: to 8:05:00 is as follows.

Advertising space number: 2

Advertisement insertion date: Jan. 1, 2001

Advertisement insertion day of the week: Tuesday

Advertisement insertion time: 8:00:00

Advertisement end time: 8:05:00

Distribution region: San Diego

Advertising space type: null

Advertisement type: ADC1 (banner advertising)

Channel information: ABC (example)

Content information: Titanic (example)

Next advertising space number: 3

\mathring{3} through \mathring{6} Hence, upon receiving the above advertising space information from the advertising space information transmission/reception means 431, the advertising space information processing means 432 stores the advertising space information in the advertising space information database 452d of the storage device 452.

The content distribution apparatus 300 transmits advertising space 2 information and advertising space 3 information in \mathring{3} and \mathring{4} shown in FIG. 20 and finally transmits advertising space n information in \mathring{5}. The content distribution apparatus 300 designates 0 as the next advertising space number, thereby indicating the transmission of the final advertising space number.

Upon receiving the advertising space n information, the advertising space information transmission/reception means 431 transmits the reception end notification to the content distribution apparatus 300. The transmission/reception protocol shown in FIG. 20 is merely an example. Instead, for example, information may be transmitted for each advertising space group (group of continuous advertisements). An advertisement time may be set in place of the advertisement end time. The presence of ADC1 through ADC5 may be transmitted. The distribution region may set as “known”, and transmission of the distribution region may be omitted five times. Alternatively, calendar information may be prepared, and distribution may be suspended in a certain day of the week.

2) Credit Information Registration Processing (S402 through S404)

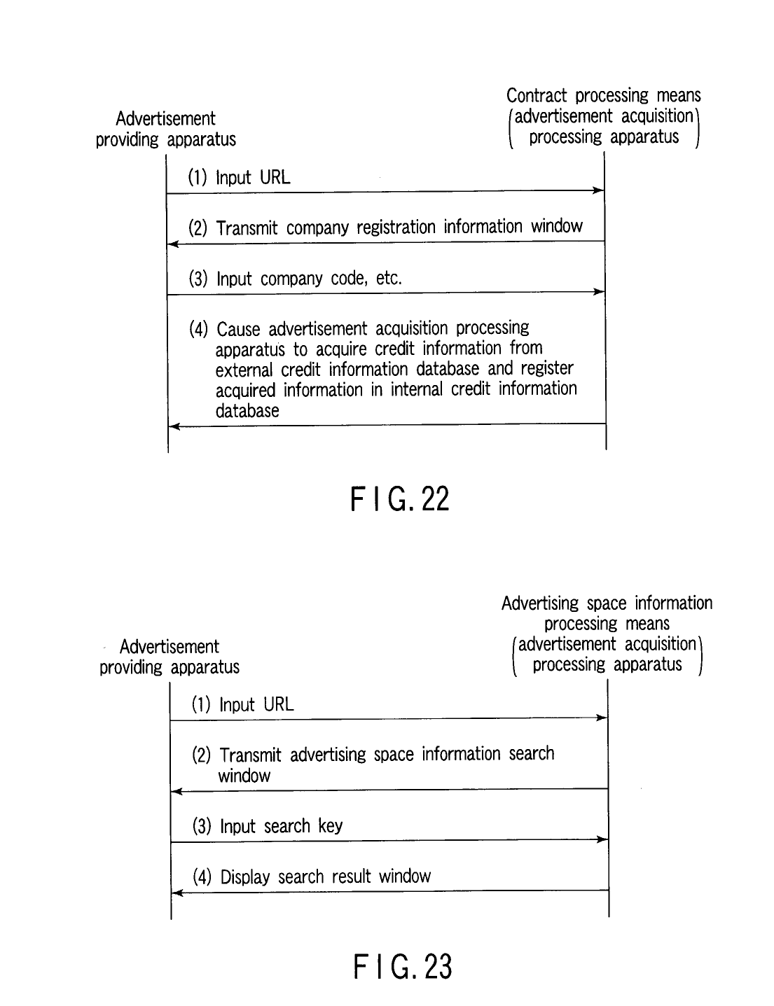

After the end of reception of advertising space information or at an appropriate timing, the advertisement acquisition processing apparatus 400 registers the advertisement providing apparatus 5 and acquires and registers the credit information of the advertisement providing apparatus 5. FIG. 22 is a sequence chart showing credit information acquisition protocol between the advertisement providing apparatus 5 and the contract processing means 414 of the advertisement acquisition processing apparatus 400.

\mathring{1} The advertisement providing apparatus 5 accesses a URL for company registration, which is open to the public on the advertisement acquisition processing apparatus 400 side, to acquire necessary information from the advertisement acquisition processing apparatus 400. The advertisement providing apparatus 5 has an information transmission/reception means 513 for transmitting/receiving information on the basis of a protocol such as HTTP and TCP/IP and a display means 514 for displaying a document described in HTML language (FIG. 17).

In the advertisement acquisition processing apparatus 400, when the advertisement providing apparatus 5 accesses the URL, the contract processing means 414 having a WEB server function is notified of the access by an HTTP GET request or the like.

\mathring{2} The contract processing means 414 and document input/output means 415 transmit a company registration information window to the advertisement providing apparatus 5 by HTTP protocol. The advertisement providing apparatus 5 displays the company registration information protocol by the display means 514.

\mathring{3} The advertisement providing apparatus 5 inputs, to the advertisement acquisition processing apparatus 400, a company code which is registered in an external company credit information service agency with an agreement in advance using the input means 512 such as a keyboard or mouse. A company that is not registered in the company credit information service agency inputs a message representing it (S402). The input data is normally sent to the contract processing means 414 having a WEB server function by a HTTP POST request.

\mathring{4} Upon receiving the company code through the document input/output means 415, the contract processing means 414 of the advertisement acquisition processing apparatus 400 activates another process. The contract processing means 414 accesses a terminal (not shown) held by the external company credit information service agency, receives, the credit information, and registers it in the credit information database 452a of the storage device 452 (S404).

For a company that is not registered in the company credit information service agency (i.e., a company having no company code), the contract processing means 414 of the advertisement acquisition processing apparatus 400 transmits a window with the following information to the advertisement providing apparatus 5. The contract processing means 414 confirms whether all necessary elements of company information are input, and if some elements are absent, notifies the advertisement providing apparatus 5 of it. When all elements of company information are input, the company is registered in the credit information database 452a of the storage device 452 (S403).

<Credit Information Database 452a>

Address

Representative director

Contact address

E-mail address

Number of employees

Contents of operations

Yearly sales information

Main business connections (including banks)

Balance sheet

5) Advertising Space Information Display Processing (S405)

The advertisement providing apparatus 5 side examines advertising space purchase. FIG. 23 is a sequence chart showing the advertising space information display protocol between the advertisement providing apparatus 5 and the advertising space information processing means 432. For this advertising space information display processing, a description of the same realizing means and technique as those used in 2) through 4) described above will be omitted here.

\mathring{1} The advertisement providing apparatus 5 accesses the advertisement acquisition processing apparatus 400 on the basis of an independently received URL for advertising space information display.

\mathring{2} The advertising space information processing means 432 having the normal WEB server function in the advertisement acquisition processing apparatus 400 transmits an advertising space information search window to the advertisement providing apparatus 5. This search window has the following search keys.

<Advertising Space Information Search Keys>

The search keys are used to search for channel information, date information, time information, region information, free space information, and content genre information.

\mathring{3} The advertisement providing apparatus 5 inputs search keys on the advertising space information search window. For example, to display information about advertising spaces in ABC distributing from 8:00 pm in February 1, the channel number (ABC), date information (February 1), and time information (8:00 pm) are input.

\mathring{4} The advertisement management means 442 acquires information about advertising spaces from the advertising space information database 452d using CGI on the basis of the above-described three keys, generates an advertising space purchase window, and transmits advertising space sales information to the advertisement providing apparatus 5. FIG. 24 is a view showing the advertising space sales window. The advertisement providing apparatus 5 displays the advertising space sales window.

In the advertising space sales information, advertising spaces at the date/time (from 8:00 pm to 10:00 pm in February 1) in a predetermined period (e.g., one month) are displayed as rectangle frames, as shown in FIG. 24. The transverse direction indicates time. Detailed information related to the content to be distributed at the date/time is displayed. Rectangular frames equal in number to the types of advertisements are present (in FIG. 24, one image advertisement and five banner advertising areas ADC1 to ADC5, i.e., a total of six frames).

For the distribution region, not only the global region but also all regions covered by the system can be selected. Same time can be selected for each week (belt selection) or for the same day of the week (box selection). Alternatively, the actual watching image window on the viewer side may be displayed before display of the advertising space sales window and changed to the advertising space sales window by clicking on an advertisement portion (banner advertising or image itself).

6) Watching Information Disclosure Processing (S406)

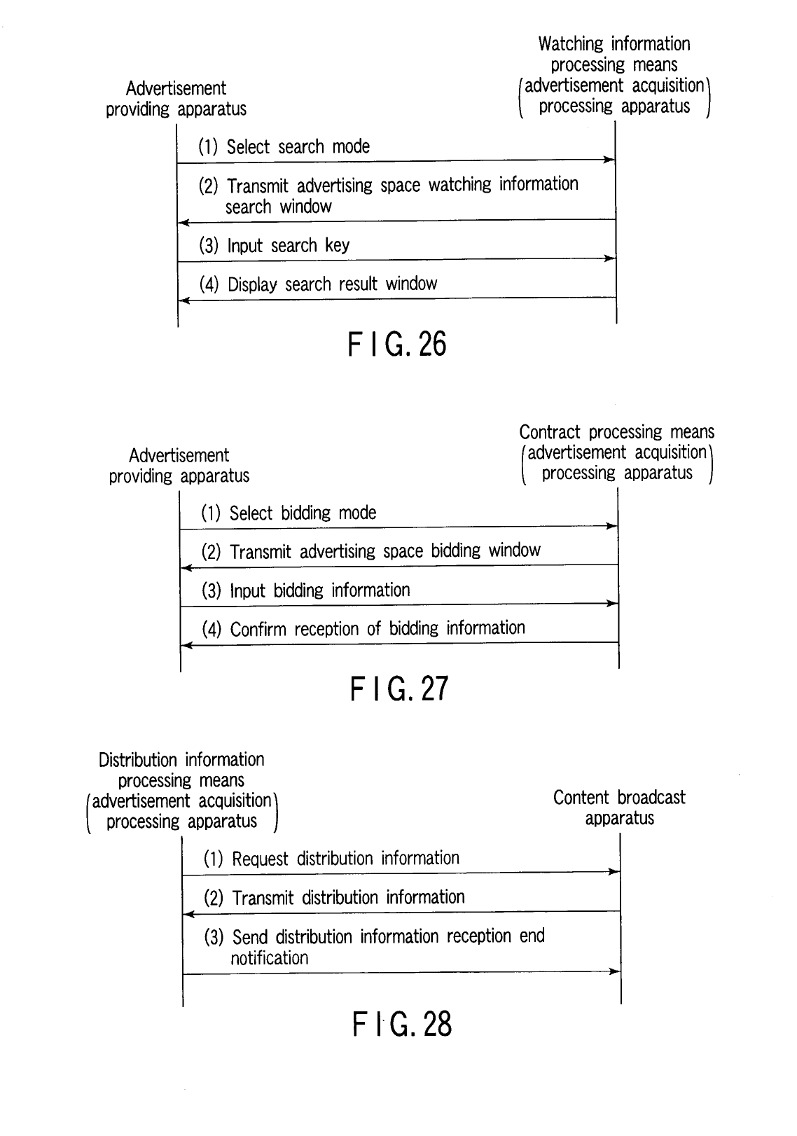

Before purchase of advertising spaces, the advertisement provider requests, using the advertisement providing apparatus 5, the past watching information of the advertising spaces of the watching information processing means 422 through the watching information transmission/reception means 423 of the advertisement acquisition processing apparatus 400, browses the watching information, and then decides actual purchase. FIG. 26 is a sequence chart showing a protocol for watching information disclosure.

\mathring{1} The advertisement providing apparatus 5 clicks on, e.g., a search mode selection button as part of the advertising space sales window described above. With this click, actually, an HTTP GET request for WEB page acquisition is sent to the watching information processing means 422 having a WEB function.

\mathring{2} Upon receiving the GET request, the watching information processing means 422 provides, to the advertisement providing apparatus 5, a picture window for advertising space sales (FIG. 24) and a display window for search key selection for the period, viewer (age group and sex), content type, and advertisement type.

\mathring{3} When the advertisement providing apparatus 5 designates a search key before clicking on an advertising space at a portion to be examined for advertising space purchase, the past watching information of the advertising space is displayed.

Search example 1: When a date and viewer are designated, the number of target viewers and the number of viewers at that date are displayed for each age group and sex.

Search example 2: When a period and viewer are designated, the number of target viewers and the total number of viewers in the period are displayed.

Search example 3: When a period and content are designated, the number of times of distribution of the content in the period are displayed for each genre.

Search example 4: When a period and advertising content are designated, the number of times of distribution of the advertising content in the period are displayed for each genre.

Search example 5: When a period, content, and advertising content are designated, merchandise genres of distribution advertisements are displayed for each content genre.

\mathring{4} The watching information processing means 422 transmits the search keys designated by the advertisement providing apparatus 5 to another excellent content selection unit (not shown) using CGI and stores the keys in an appropriate storage area of the storage device 452. The watching information is provided to the viewer apparatus 2 as a bar graph or the like in accordance with the inspection key designation contents.

7) Bidding Information Reception Processing (S407)

When the advertisement provider sees watching information from the advertisement providing apparatus 5 and decides bidding, he/she executes bidding processing. The bidding prices of the respective companies during the bidding period cannot be referred to. FIG. 27 is a sequence chart showing a bidding information reception protocol between the advertisement providing apparatus 5 and the contract processing means 414 of the advertisement acquisition processing apparatus 400.

\mathring{1} The advertisement providing apparatus 5 designates a desired space from the advertising space sales window described above and then clicks on a bid button. With this click, actually, an HTTP GET request for WEB page acquisition is sent to the contract processing means 414 having a WEB function.

\mathring{2} Upon receiving the GET request, the contract processing means 414 forms the advertising space bidding window and transmits it to the advertisement providing apparatus 5. The advertising space bidding window has a display portion where contents agreed in the advertising space sales window are confirmed and an input portion. For the display portion, an advertising space code is used as a search key, and information is searched from the advertising space information database 452d of the storage device 452. This searching may be executed using, e.g., CGI. The contract processing means 414 merges an input field with the information of the display portion obtained by searching and transmits the advertising space bidding window to the advertisement providing apparatus 5.

The pieces of information displayed in the display portion are as follows.

<Display Portion>

Period: e.g., Feb. 1 through 31, 2002

Date/time: e.g., Feb. 1, 2002, 8:00 through 8:15

Advertisement type: e.g., image advertisement

Distribution region: San Diego

Option purchase: e.g., box purchase

Dynamic inserted advertisement distribution price: decided by operator

On the other hand, the following information input field is formed in the input portion.

<Input Portion>

Bidding price

Right to secondary use: e.g., YES

Dynamic distribution: e.g., YES

Advertising content format: e.g., AVID, MS, WMT, etc.

Target customer information: age group, sex, region, income, family, etc.

a) Bidding Price

For the bidding price, a minimum bidding price is set, thereby excluding impractical bidding. The bidding price is proportional to the current TV GRP (Gross Rating Point). The GRP is calculated by past average audience rating of advertising space to be sold×a. The value a is decided by the operator.

GRP=(number of viewers 1+number of viewers 2, . . . , number of viewers n)/(number of viewers 1+number of viewers 2, . . . , number of viewers n)

b) Right to Secondary Use

The presence/absence of a right to alteration from the advertisement providing apparatus 5 is confirmed. Even when there is no right to alteration, conversion to an advertising window format or change of CODEC is possible if, e.g., the resolution must be changed depending on the presence/absence of banner advertising. In this item, however, a right to make a secondary work using the advertisement is confirmed.

c) Dynamic Advertisement and Target Customer Information

A dynamic advertisement is an advertisement that is acquired for an unbidden advertising space and inserted to it. Target customer information defines the insertion conditions. The content distribution apparatus 300 automatically inserts advertisements when supposed viewers satisfy the target customer information to some degree.

The target customer information contains the following elements. A distribution time limit defines a period in which advertisements can automatically be inserted and distributed.

<Target Customer Information>

The target customer information contains, e.g., the age group, sex, region, income, family, and distribution time limit.

d) Advertising Content Format

It is necessary to acquire uncompressed digital advertising contents as much as possible.

In this example, bidding prices cannot be referred to. However, bidding prices may be presented to other bidders in a form of auction. Instead of using bidding, a price may be set as an advertising fee by calculation, and advertising spaces may simply be sold at the price.

\mathring{3} Upon receiving and displaying the advertising space bidding window, the advertisement providing apparatus 5 sets a bidding price higher than the minimum biding price, selects other optional items, and transmits the bidding information to the contract processing means 414 as an HTTP POST request.

\mathring{4} Using the advertising space code as a key, the contract processing means 414 stores the contents of the above-described input field and the bidding information in the bidding information database 452b of the storage device 452. The bidding information database 452b stores the following information.

<Bidding Information Database 452b>

Advertising space code

Company code (bidding company)

Bidding price

Right to secondary use: e.g., YES

Dynamic distribution: e.g., YES

Advertising content format

Target customer information

8) Contract Processing (S408)

A company that has presented the highest price within a predetermined period makes a successful bid for an advertising space. After the bidding period, notifications are sent to the successful bidder and bidders on the second and third places. After the elapse of a predetermined period, the contract processing means 414 in the advertisement purchase section 410 compares the bidding prices for each advertising space code and extracts the successful bidder with the highest bidding price and bidders on the second and third places.

After the successful bidder is decided from the bidding price, the contract processing means 414 extracts the right to secondary use and target customer information from the bidding information database 452b and extracts information (channel, date/time, region information, and the like) about the advertising space from the advertising space information database 452d using the advertising space code as a key. The contract processing means 414 creates a business document with a clearly written term of validity of highest bid price and contract wording and sends the document to the successful bidder company by e-mail or the like. Similar wording is sent to the bidders on the second and third places while clearly describing that they are on the second and third places.

The advertisement providing apparatus 5 signs the contract and electronically transmits the contract. The contract is thus made. After the contract is made, a contract code is issued. The contract may be transmitted by mail.

After the contract is made, using the company code of the party of contract as a key, sales information is generated using the information stored in the bidding information database 452b and stored in the sales information database 452c. The sales information database 452c stores the following information.

<Sales Information Database 452c>

The sales information database 452c stores the company code, advertising space code, contract code, advertising content code (newly issued), advertising content information code (newly issued), sales price, presence/absence of right to secondary use, presence/absence of dynamic distribution, advertising content format, target customer information, and the like.

9) Accounting Settlement Processing (S409)

After the contract is made, the accounting processing means 412 that has received the contract conclusion information executes accounting settlement with respect to the advertisement providing apparatus 5. This accounting settlement processing is performed using the terminal 6 held by, e.g.,. a financial institution or credit company serving as an external accounting settlement service agency. Before accounting settlement processing, the advertisement provider joins the service of the accounting settlement service agency. Hence, the accounting processing means 412 extracts necessary information from the credit information database 452a and sales information database 452c and transmits the information in accordance with the protocol of the terminal 6 held by the accounting settlement service agency.

10) Advertising Content and Advertising Content Information Reception Processing (S410)

After the end of accounting settlement processing, the advertisement providing apparatus 5 transmits the advertising contents and advertising content information to the advertisement management means 442 of the advertisement acquisition processing apparatus 400. The advertisement management means 442 receives the advertising contents and advertising content information and stores them in the advertising content database 452e and advertising content information database 452f. The advertising contents and advertising content information are transferred using a protocol such as a TCP/IP or FTP.

<Advertising Content Information Database 452f>

The advertising content information database 452f stores advertising content information such as the advertising content code, advertising space code, video format, content time, author, date/time of creation, copyrighter, compression CODEC (null for noncompression), hash value of advertising content, storage address of advertising content (URL address of storage), distribution time limit (null when no limit is set).

A WEB server function may be prepared on the advertisement management means 442 side. When the advertisement providing apparatus 5 accesses the advertisement management means 442 by a URL, a WEB page window having a field in which pieces of information as advertising content information are to be input may be presented to the advertisement providing apparatus 5, and the advertisement providing apparatus 5 may input necessary information. In this case, the advertisement management means 442 generates an advertising content information format on the basis of the input information.

11) Advertising Content/Advertising Content Information Distribution Processing (S411)

The advertisement management means 442 transmits the advertising contents and advertising content information to the external content distribution apparatus 300. For this transmission, an existing protocol such as TCP/IP or FTP is used.

12) Distribution to End User (S412)

The content distribution apparatus 300 actually executes distribution to the end user. If advertisements are to be dynamically inserted, the content distribution apparatus 300 records distribution information (number of times of distribution, distribution region, watching information, and the like) in advance.

13) Distribution Information Processing (S413)

This distribution information processing is processing of receiving distribution information from the content distribution apparatus 300. FIG. 28 is a sequence chart showing a distribution information reception protocol between the distribution information processing means 411 and the content distribution apparatus 300.

The distribution information processing means 411 receives distribution information from the content distribution apparatus 300 and stores it in the distribution information database 452g of the storage device 452.

\mathring{1} The distribution information processing means 411 periodically checks the distribution time limit stored in the advertising content information database 452f. If the distribution time limit comes soon, the distribution information processing means 411 notifies the content distribution apparatus 300 of it. After the distribution time limit, the distribution information processing means 411 transmits a distribution information request to the content distribution apparatus 300 together with the content code.

\mathring{2} The content distribution apparatus 300 transmits distribution information. The distribution information contains the number of times of distribution of advertisements except the bidden advertising spaces (number of times of distribution of dynamic advertisements) and distribution region information. The distribution information processing means 411 stores the distribution information in the distribution information database 452g using the advertising content code as a key. The distribution information database 452g stores the following information.

<Distribution Information Database 452g>

Advertising content code

Number of times of distribution

Distribution region (number of times) and other necessary information

The distribution information processing means 411 also searches the sales information database 452c for information of the distribution region and the like using the advertising content code as a key and confirms whether the target customer information, including the distribution region, is satisfied. If the target customer information is not satisfied, the distribution information processing means 411 notifies the content distribution apparatus 300 of it. If the target customer information is satisfied, the distribution information processing means 411 writes the number of times of distribution in the distribution information database 452g.

\mathring{3} Upon receiving the distribution information, the distribution information processing means 411 transmits a reception end notification to the content distribution apparatus 300. The distribution information processing means 411 also notifies the accounting processing means 412 that an additional advertising fee should be collected.

14) Additional Accounting Settlement Processing (S414)

This additional accounting settlement processing is processing of collecting an additional advertising fee according to the number of times of distribution. Advertising fee collection is done between the accounting processing means 412 and the terminal 6 held by an external accounting settlement facility, as in the accounting settlement processing in step S409. More specifically, on the basis of the advertising content code and the number of times of distribution, which are stored in the distribution information database 452g, the accounting processing means 412 collects an additional advertising fee given by the number of times of distribution×q (q is decided by the operator) from the advertisement provider through the terminal 6 held by the external accounting settlement facility.

According to the embodiment of the advertisement acquisition processing apparatus 400 having the above arrangement, advertising space sales information is generated from advertising space information generated by the content distribution apparatus 300 and disclosed to the advertisement providing apparatus 5. Advertising spaces to which advertisements are to be inserted are sold to the advertisement provider. After the end of contract processing, advertising contents and advertisements are inserted to the advertising spaces of a program and distributed to the viewer apparatus 2. The advertising fee at the initial contract and additional advertising fee according to the number of times of distribution are calculated. The profit is returned to the content providing apparatus 4 and viewer apparatus 2 on the basis of the advertising fee and additional advertising fee. Hence, supply of excellent contents and advertisements can be promoted. In addition, the profit can be returned to the content providing apparatus 4 and viewer apparatus 2 in accordance with the degree of contribution to advertisement watching.

The apparatuses 100 through 400 have the storage management processing sections 150, 240, 360, and 450, respectively. Instead, a database server may be installed in the network apparatus 1 or an office LAN connected to the apparatuses 100 through 400 and shared by them (FIG. 1).

The present invention is not limited to the above embodiments, and various changes and modifications can be made within the spirit and scope of the invention. The embodiments can be combined as much as possible. In this case, a combined effect is obtained. The embodiments incorporate inventions of various generic and species stages, and various inventions can be extracted by appropriately combining a plurality of constituent elements disclosed. For example, when an invention is extracted by omitting some constituent elements from all the constituent elements described in “summary of the invention”, and the extracted invention should be practiced, the omitted parts are appropriately compensated by known techniques.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic merchandise distribution system in which a content providing apparatus and a viewer apparatus are connected through a network and which evaluates/analyzes a content for content buying for the content providing apparatus, comprising:
a content evaluation apparatus which acquires content watching information collected by the viewer apparatus and necessary information from the network apparatus, evaluates/analyzes an excellent content in accordance with a predetermined evaluation method and evaluation items, and outputs an evaluation/analysis result containing content information of the excellent content; and
a content buying apparatus which receives the evaluation/analysis result containing the content information output from the content evaluation apparatus, generates order data in which the content information and purchase price of the excellent content are described on the basis of the evaluation/analysis result, transmits the order data to the content providing apparatus, and makes a content buying contract from reply data to the order data.

2. An electronic merchandise distribution system in which a content providing apparatus and a viewer apparatus are connected through a network and which evaluates/analyzes a necessary content on the basis of a content buying request, comprising:
a content buying apparatus which transmits the content buying request to a content evaluation apparatus, upon receiving content information of an excellent content evaluated/analyzed on the basis of watching information collected from the viewer apparatus and necessary information collected from the network in accordance with the buying request, generates order data in which the content information and purchase price of the excellent content are described, transmits the order data to the content providing apparatus, and makes a content buying contract from reply data to the order data; and
a content evaluation apparatus which receives the content buying request from the content buying apparatus, evaluates/analyzes the content in accordance with a predetermined evaluation method and evaluation items on the basis of the content watching information collected by the viewer apparatus and necessary information collected from the network apparatus, and transmits an evaluation/analysis result to the content buying apparatus.

3. An electronic merchandise distribution system in which a content providing apparatus and a viewer apparatus are connected through a network and which executes processing of buying a content from the content providing apparatus, comprising:
a content buying apparatus which generates order data in which content information and purchase price of an excellent content having predetermined evaluation are described, transmits the order data to the content providing apparatus, makes a content buying contract from reply data to the order data, and acquires a content and content information related to the excellent content from the content providing apparatus; and
a content distribution apparatus which receives the content and content information from the content buying apparatus, schedules a temporary program from the content and content information, generates program guide data on the basis of the temporary program schedule and provides the program guide data to the viewer apparatus, and acquires program selection data from the viewer apparatus.

4. An electronic merchandise distribution system in which a content providing apparatus and an advertisement providing apparatus are connected through a network and which acquires an advertising space to which an advertisement from the advertisement providing apparatus is to be inserted when a content is bought from the content providing apparatus, comprising:
a content buying apparatus which generates order data in which content information and purchase price of an excellent content having predetermined evaluation are described, transmits the order data to the content providing apparatus, makes a content buying contract from reply data to the order data, and acquires content information related to the excellent content from the content providing apparatus;
a content distribution apparatus which receives the content and content information from the content buying apparatus, generates advertising space information from the content and content information, and provides the advertising space information to the advertisement providing apparatus; and
an advertisement acquisition processing apparatus which, upon receiving advertising space sales contract for advertisement insertion from the advertisement providing apparatus that has confirmed the advertising space information transmitted from the content distribution apparatus, acquires advertising content information and an advertising content from the advertisement providing apparatus.

5. A system according to claim 4, wherein upon receiving the advertising content information and advertising content from the advertisement acquisition processing apparatus, the content distribution apparatus generates distribution control information containing a content whose program schedule advertising space has an advertisement inserted and distributes the content with the advertisement inserted to a viewer apparatus in accordance with the generated distribution control information.

6. An electronic merchandise distribution system in which a viewer apparatus, a content providing apparatus, and an advertisement providing apparatus are connected through a network and which distributes electronic merchandise formed from a content or an advertisement, comprising:
a content buying apparatus which transmits a buying request for the content, upon receiving content information of an excellent content evaluated/analyzed on the basis of viewer information collected from the viewer apparatus and necessary information collected from the network on the basis of the buying request, generates order data in which the content information and purchase price of the excellent content are described, transmits the order data to the content providing apparatus, makes a content buying contract from reply data to the order data, and acquires the content and content information from the content providing apparatus;
a content evaluation apparatus which receives the content buying request from the content buying apparatus, evaluates/analyzes the content in accordance with an evaluation method and evaluation items stored in advance on the basis of the content watching information collected by the viewer apparatus and necessary information collected from the network apparatus, and transmits an evaluation/analysis result to the content buying apparatus;
a first content distribution apparatus which receives the content and content information from the content buying apparatus and generates and transmits advertising space information on the basis of a temporary program schedule based on the content and content information;
an advertisement acquisition processing apparatus which causes the advertisement providing apparatus to display the advertising space information transmitted from the first content distribution apparatus, acquires advertising content information from the advertisement providing apparatus on the basis of the advertising space information in accordance with an advertising space sales contract to insert an advertisement, acquires an advertising content from the advertisement providing apparatus, and transmits the advertising content information and advertising content; and
a second content distribution apparatus which, upon receiving the advertising content information and advertising content from the advertisement acquisition processing apparatus, generates distribution control information containing a content and advertisement inserted into an advertising space of a program scheduled on the basis of the temporary program, and distributes the content with the advertisement inserted to the viewer apparatus in accordance with the generated distribution control information.

7. A system according to claim 1, wherein the buying apparatus comprises
a contract/sales management processing section which acquires information necessary for content buying processing from the content evaluation apparatus, deciding the purchase price in accordance with a predetermined purchase content price deciding scheme, transmits the order data in which the purchase price and the content information to be purchased are described to the content providing apparatus, and makes a purchase contract,
an arrival management processing section which receives purchase contract conclusion information from the contract/sales management processing section, performing receiving inspection for the content and content information sent from the content providing apparatus, and stores the content and content information, and
an accounting management processing section which executes accounting settlement processing for the purchased content on the basis of the purchase contract conclusion information from the contract/sales management processing section and receiving inspection information from the arrival management processing section.

8. A system according to claim 2, wherein the buying apparatus comprises
a contract/sales management processing section which acquires information necessary for content buying processing from the content evaluation apparatus, deciding the purchase price in accordance with a predetermined purchase content price deciding scheme, transmits the order data in which the purchase price and the content information to be purchased are described to the content providing apparatus, and makes a purchase contract,
an arrival management processing section which receives purchase contract conclusion information from the contract/sales management processing section, performing receiving inspection for the content and content information sent from the content providing apparatus, and stores the content and content information, and
an accounting management processing section which executes accounting settlement processing for the purchased content on the basis of the purchase contract conclusion information from the contract/sales management processing section and receiving inspection information from the arrival management processing section.

9. A system according to claim 3, wherein the buying apparatus comprises
a contract/sales management processing section which acquires information necessary for content buying processing from the content evaluation apparatus, deciding the purchase price in accordance with a predetermined purchase content price deciding scheme, transmits the order data in which the purchase price and the content information to be purchased are described to the content providing apparatus, and makes a purchase contract,
an arrival management processing section which receives purchase contract conclusion information from the contract/sales management processing section, performing receiving inspection for the content and content information sent from the content providing apparatus, and stores the content and content information, and
an accounting management processing section which executes accounting settlement processing for the purchased content on the basis of the purchase contract conclusion information from the contract/sales management processing section and receiving inspection information from the arrival management processing section.

10. A system according to claim 4, wherein the buying apparatus comprises
a contract/sales management processing section which acquires information necessary for content buying processing from the content evaluation apparatus, deciding the purchase price in accordance with a predetermined purchase content price deciding scheme, transmits the order data in which the purchase price and the content information to be purchased are described to the content providing apparatus, and makes a purchase contract,
an arrival management processing section which receives purchase contract conclusion information from the contract/sales management processing section, performing receiving inspection for the content and content information sent from the content providing apparatus, and stores the content and content information, and
an accounting management processing section which executes accounting settlement processing for the purchased content on the basis of the purchase contract conclusion information from the contract/sales management processing section and receiving inspection information from the arrival management processing section.

11. A system according to claim 5, wherein the buying apparatus comprises
a contract/sales management processing section which acquires information necessary for content buying processing from the content evaluation apparatus, deciding the purchase price in accordance with a predetermined purchase content price deciding scheme, transmits the order data in which the purchase price and the content information to be purchased are described to the content providing apparatus, and makes a purchase contract,
an arrival management processing section which receives purchase contract conclusion information from the contract/sales management processing section, performing receiving inspection for the content and content information sent from the content providing apparatus, and stores the content and content information, and
an accounting management processing section which executes accounting settlement processing for the purchased content on the basis of the purchase contract conclusion information from the contract/sales management processing section and receiving inspection information from the arrival management processing section.

12. A system according to claim 6, wherein the buying apparatus comprises
a contract/sales management processing section which acquires information necessary for content buying processing from the content evaluation apparatus, deciding the purchase price in accordance with a predetermined purchase content price deciding scheme, transmits the order data in which the purchase price and the content information to be purchased are described to the content providing apparatus, and makes a purchase contract,
an arrival management processing section which receives purchase contract conclusion information from the contract/sales management processing section, performing receiving inspection for the content and content information sent from the content providing apparatus, and stores the content and content information, and
an accounting management processing section which executes accounting settlement processing for the purchased content on the basis of the purchase contract conclusion information from the contract/sales management processing section and receiving inspection information from the arrival management processing section.

13. A system according to claim 1, wherein the content evaluation apparatus comprises
an evaluation/analysis management processing section which, upon receiving an evaluation/analysis request from each apparatus in the system, sets at least information of an evaluation method and evaluation items corresponding to the request contents,
a data collection processing section which collects information necessary for the evaluation items from the network apparatus and viewer apparatus in accordance with the evaluation items set by the evaluation/analysis management processing section, and
a data analysis processing section which evaluates/analyzes the request contents using the information collected by the data collection processing section and the evaluation method set by the evaluation/analysis management processing section, and
the evaluation/analysis result is transmitted to the requesting apparatus.

14. A system according to claim 2, wherein the content evaluation apparatus comprises
an evaluation/analysis management processing section which, upon receiving an evaluation/analysis request from each apparatus in the system, sets at least information of an evaluation method and evaluation items corresponding to the request contents,
a data collection processing section which collects information necessary for the evaluation items from the network apparatus and viewer apparatus in accordance with the evaluation items set by the evaluation/analysis management processing section, and
a data analysis processing section which evaluates/analyzes the request contents using the information collected by the data collection processing section and the evaluation method set by the evaluation/analysis management processing section, and
the evaluation/analysis result is transmitted to the requesting apparatus.

15. A system according to claim 3, wherein the content distribution apparatus comprises
a content processing section which receives the content and content information sent from the content buying apparatus in accordance with content buying, executes appropriate protection processing, and outputs the content and content information,
a content-advertisement processing section which schedules advertising space information and temporary program data on the basis of the content information output from the content processing section and the watching information from the content evaluation apparatus, provides the advertising space information to the advertisement providing apparatus, upon receiving an advertising content and advertising content information from the advertisement providing apparatus on the basis of an advertising space purchase contract, generates a program schedule containing the content having an advertisement inserted, and generates program distribution control information on the basis of the program schedule data, and
a content-advertisement distribution section which distributes the program containing the advertisement and content on the basis of the program distribution control information generated by the content-advertisement processing section.

16. A system according to claim 4, wherein the content distribution apparatus comprises
a content processing section which receives the content and content information sent from the content buying apparatus in accordance with content buying, executes appropriate protection processing, and outputs the content and content information,
a content-advertisement processing section which schedules advertising space information and temporary program data on the basis of the content information output from the content processing section and the watching information from the content evaluation apparatus, provides the advertising space information to the advertisement providing apparatus, upon receiving an advertising content and advertising content information from the advertisement providing apparatus on the basis of an advertising space purchase contract, generates a program schedule containing the content having an advertisement inserted, and generates program distribution control information on the basis of the program schedule data, and
a content-advertisement distribution section which distributes the program containing the advertisement and content on the basis of the program distribution control information generated by the content-advertisement processing section.

17. An electronic merchandise distribution method in which a viewer apparatus, a content providing apparatus, and an advertisement providing apparatus are connected through a network and which distributes electronic merchandise formed from a content or an advertisement, comprising:
the content buying step of transmitting a buying request for the content to a content evaluation apparatus to be described later, upon receiving content information of an excellent content evaluated/analyzed on the basis of watching information collected from the viewer apparatus and necessary information collected from the network on the basis of the buying request, generating order data in which the content information and purchase price of the excellent content are described, transmitting the order data to the content providing apparatus, making a content buying contract from reply data to the order data, and acquiring the content and content information from the content providing apparatus;
the content evaluation step of receiving the content buying request from the content buying apparatus, evaluating/analyzing the content in accordance with an evaluation method and evaluation items stored in advance on the basis of the content watching information collected by the viewer apparatus and necessary information collected from the network apparatus, and transmitting an evaluation/analysis result to the content buying apparatus;
the first content distribution step of receiving the content and content information in the content buying step, generating advertising space information from the content and content information, and providing the advertising space information to the advertisement providing apparatus;
the advertisement acquisition processing step of confirming the advertising space information transmitted in the first content distribution step, acquiring advertising content information and advertising content from the advertisement providing apparatus in accordance with an advertising space sales contract to insert an advertisement, and transmitting the advertising content information and advertising content; and
the second content distribution step of, upon receiving the advertising content information and advertising content in the advertisement acquisition processing step, generating distribution control information containing a content and advertisement inserted into an advertising space of a program, and distributing the advertising content to the viewer apparatus connected to the network in accordance with the generated distribution control information.

18. An electronic merchandise distribution method in which a viewer apparatus, a content providing apparatus, and an advertisement providing apparatus are connected through a network and which distributes electronic merchandise formed from a content or an advertisement, comprising:
the watching information collection step of causing the viewer apparatus to collect global content watching information from the viewer apparatus that watches a global content;
the step of accumulating the global content watching information acquired from a plurality of viewer apparatuses and extracting an excellent content on the basis of predetermined evaluation/analysis based on the accumulation result; and
the step of executing negotiation with the content providing apparatus for a purchase price of the excellent content on the basis of content information of the excellent content extracted in the extracting step, making a purchase contract, and acquiring a content and content information from the content providing apparatus.

19. A method according to claim 18, further comprising
the advertising space information generation step of scheduling a temporary program from the content and the content information acquired in the content information acquisition step and generating advertising space information from the scheduled temporary program,
the step of transmitting the advertising space information generated in the advertising space information generation step to the advertisement providing apparatus and acquiring advertising content information and advertising content from the advertisement providing apparatus on the basis of an advertising space information sales contract,
the content distribution step of, after the advertising space information sales contract in the advertising content information and advertising content acquisition step, scheduling a program on the basis of the temporary program schedule, and distributing the advertising content containing the content having the advertising content inserted into the advertising space information of the program to the viewer apparatus, and
the step of calculating an advertising fee collection amount on the basis of distribution information containing at least the number of times of distribution by distribution of the advertising content in the content distribution step and billing information for the viewer apparatus, billing the advertising fee to the advertisement providing apparatus, paying back the calculated advertising fee collection amount to a provider of the content providing apparatus, and compensating a fee corresponding to a discount to a viewer of the viewer apparatus.

20. A computer-readable program for causing a computer to which at least a content providing apparatus is connected through a network and which executes processing of buying a content from the content providing apparatus to realize:
a function of deciding a purchase price of a necessary content on the basis of a predetermined purchase content purchase price deciding scheme;
a buying search function of, after the purchase price is decided by the purchase price deciding function, searching a database which stores sellers in advance for a seller;
a content search processing function of comparing content information of the seller found by the search function with past content information stored in advance and selecting content information of the content to be bought;
a function of transmitting order data in which the purchase price is described on the basis of the selected content information to the content providing apparatus and acquiring reply data from the content providing apparatus;
a function of, upon determining on the basis of the replay data obtained by the function that a contract can be made, generating contract data and transmitting the contract data to the content providing apparatus to make a contract;
a content receiving inspection function of receiving the content and content information from the content providing apparatus after the contract is made, and performing receiving inspection of the contents; and
a function of, upon receiving contract conclusion and content receiving inspection, executing accounting settlement processing on the basis of bill data from the content providing apparatus.

21. A computer-readable program for causing a computer to which a viewer apparatus is connected through a network and which executes evaluation/analysis on the basis of an input evaluation/analysis request to realize:
a function of setting and outputting at least information of an evaluation method and evaluation items corresponding to the evaluation/analysis request contents;
a data collection processing function of collecting information that requires the evaluation items from the network and viewer apparatus in accordance with the evaluation items set by the function;
a data analysis processing function of evaluating/analyzing the request contents using the information collected by the data collection processing function in accordance with the set and output evaluation method; and
a function of converting an evaluation/analysis result obtained by the analysis processing function into predetermined report form data and transmitting the report form data to an evaluation/analysis request destination.

22. A computer-readable program for causing a computer to which a content buying apparatus, an advertisement providing apparatus, and a viewer apparatus are connected through a network and which buys a content from the content buying apparatus and executes distribution processing to realize:
a content processing function of receiving a content and content information sent from the content buying apparatus in accordance with content buying, executing appropriate protection processing, and outputting the content and content information;
a function of generating advertising space information and temporary program schedule data on the basis of the content information output from the content processing function and watching information watched by the viewer apparatus;
a function of providing the advertising space information generated by the function to the advertisement providing apparatus and receiving an advertising content and advertising content information from the advertisement providing apparatus on the basis of an advertising space purchase contract;
a function of generating a program schedule containing the content having an advertisement inserted by the function and generating program distribution control information on the basis of the program schedule data; and
a distribution function of distributing the program containing the advertisement and content on the basis of the program distribution control information generated by the function.
